(19) United States
(12) Patent Application Publication
(10) Pub. No.: US 2022/0180547 A1
(43) Pub. Date: Jun. 9, 2022

(54) METHOD AND APPARATUS FOR MONITORING A DISTANCE BETWEEN VIRTUAL OBJECTS AND RECOGNIZING A CONTACT OF VIRTUAL OBJECTS IN A VIRTUAL REALITY ENVIRONMENT OR IN AN AUGMENTED REALITY ENVIRONMENT

(71) Applicant: Yong Bum KIM, Seongnam-si (KR)

(72) Inventor: Yong Bum KIM, Seongnam-si (KR)

(21) Appl. No.: 17/343,096

(22) Filed: Jun. 9, 2021

(51) Int. Cl. G06T 7/70; G06T 7/20; G06T 19/00

(52) U.S. Cl. CPC G06T 7/70; G06T 2210/21; G06T 19/00; G06T 7/20

(57) ABSTRACT

Provided is a method performed by a computer device for monitoring a distance between virtual objects and recognizing a contact between virtual objects in a virtual reality environment or an augmented reality environment. The method comprises monitoring a moving speed of a first part of a first object, a moving length of the first part, and a distance between the first part and a second part of a second object, and recognizing that the first object is in contact with the second object when the distance between the first part and the second part is within a threshold distance. The moving length of the first part is a moving length during the first part moves from a first point to a second point while maintaining the moving speed equal to or greater than a threshold speed. The threshold distance may vary based on the moving length of the first part.

### BACKGROUND

### 1. Field

The present invention relates to a method for monitoring a distance between virtual objects and recognizing a contact between virtual objects in a virtual reality environment or an augmented reality environment, and an apparatus, in which the method is implemented.

### 2. Description of the Related Art

There are many differences between real space and virtual space. The real space is a physical space, in which real phenomena are sensed through human visual sense organs, auditory sense organs, tactile sense organs, olfactory sense organs, or taste organs. On the other hand, the virtual space is a kind of imitation space, in which virtual phenomena that mimic the phenomena of reality are sensed. The imitated virtual phenomena may be physically emulated stimuli such as emulated vision, emulated sound, and emulated touch, or chemically emulated stimuli such as emulated smell or emulated taste.

In general, emulated stimuli are primarily limited to visual, auditory and tactile sensations, and emulated stimuli are not sophisticated enough to simulate real-world stimuli. Therefore, it is not easy for a virtual reality user or augmented reality user to smoothly sense an emulated stimulus and to sufficiently interact with objects in a virtual space and to completely immerse themselves into virtual world in the virtual space. For example, in real space, physical collisions occur when objects come into contact with each other, and thus, it is easy to sense contact between objects. On the other hand, in a virtual space, it may be more difficult for a user to sense a contact between virtual objects, since such physical collisions do not accompany when the virtual objects contact each other. Specifically, this can be a problem when a user uses a virtual user interface such as writing text or dragging on the virtual user interface in a virtual space. It is difficult for the user to clearly recognize whether a virtual input object such as a finger of the user of a virtual pen and the virtual user interface are in contact with each other during writing text or dragging on the virtual user interface. Accordingly, there may be a problem in which writing or drawing cannot be performed in the virtual space as intended.

### SUMMARY

A technical problem to be solved through some embodiments of the present disclosure is to provide a method and an apparatus for helping a user easily perform a virtual input operation such as virtual drawing, virtual writing, and virtual drag in a virtual space.

The technical problems of the present disclosure are not limited to the technical problems mentioned above, and other technical problems that are not mentioned will be clearly understood by those skilled in the art from the following description.

To resolve the technical problems, a method for monitoring a distance between virtual objects and recognizing a contact between virtual objects in a virtual reality environment or an augmented reality environment is performed by a computer device and comprises monitoring a moving speed of a first part of a first object, a moving length of the first part, and a distance between the first part and a second part of a second object, and recognizing that the first object is in contact with the second object when the distance between the first part and the second part is within a threshold distance, wherein the moving length of the first part is a moving length during the first part moves from a first point to a second point while maintaining the moving speed equal to or greater than a threshold speed, wherein the threshold distance varies based on the moving length of the first part.

In an embodiment of the method, wherein the first point may be a position of the first part at a moment when the moving speed of the first part increases from less than the threshold speed to equal to or greater than the threshold speed, wherein the second point may be a position of the first part at a moment when the moving speed of the first part decreases from equal to or great than the threshold speed to less than the threshold speed.

In an embodiment of the method, wherein the threshold distance may be set to an initial value if the moving speed of the first part is less than the threshold speed.

In an embodiment of the method, wherein the moving speed of the first part may be a magnitude of a linear velocity of the first part at a moment when the first part moves.

In an embodiment of the method, wherein the moving speed of the first part may be a value obtained by dividing the moving length of the first part by a time taken for the first part to move from the first point to the second point.

In an embodiment of the method, wherein the moving length of the first part may be a length of the entire path that the first part moved from the first point to the second point.

In an embodiment of the method, wherein the moving length of the first part may be a straight distance between the first point and the second point.

In an embodiment of the method, wherein the first part may move in a first path while maintaining the moving speed equal to or greater than the threshold speed from a third point to a fourth point and, wherein the first point may be a point on the first path, wherein the second point may be a point having the longest straight distance from the first point among a plurality of points on the first path, wherein the moving length of the first part may be a straight distance between the first point and the second point.

In an embodiment of the method, wherein the first part may move in a first path while maintaining the moving speed equal to or greater than the threshold speed from a third point to a fourth point, wherein the first point may be a point on the first path, wherein the second point may be a point having the longest straight distance from the first point among a plurality of points on the first path, wherein the moving length of the first part may be a length of a second path, in which the first part moved from the first point to the second point.

In an embodiment of the method, wherein the threshold distance may be determined by at least one of a first relational function having the moving length of the first part as a parameter and a second relational function having the moving speed of the first part as a parameter, wherein the moving speed of the first part may be a moving speed of the first part during the first part moves from the first point to the second point while maintaining the moving speed equal to or greater than the threshold speed, wherein the threshold distance may be set to an initial value if the moving speed of the first part is less than the threshold speed.

In an embodiment of the method, wherein the moving length of the first part may be a relative moving length of the first part with respect to the second part.

In an embodiment of the method, wherein the moving speed of the first part may be a relative moving speed of the first part with respect to the second part.

In an embodiment of the method, wherein the threshold distance may vary based on the moving length of the first part while the distance between the first part and the second part is within the threshold distance, wherein the threshold distance may be set to an initial value when the distance between the first part and the second part exceeds the threshold distance.

In an embodiment of the method, wherein the threshold distance may vary based on the moving speed of the first part while the distance between the first part and the second part is within the threshold distance, wherein the threshold distance may be set to an initial value when the distance between the first part and the second part exceeds the threshold distance.

In an embodiment of the method, wherein the threshold distance may vary based on the moving length of the first part when the moving length of the first part exceeds a threshold length.

In an embodiment of the method, wherein the threshold distance may be set to an initial value if the moving length of the first part is less than the threshold length.

In an embodiment of the method, the method may further comprise displaying a first visual appearance of at least one of the first object, the second object, and a background based on the distance between the first part and the second part, displaying a second visual appearance of at least one of the first object, the second object, and the background in response to a change in the distance between the first part and the second part, wherein the first visual appearance and the second visual appearance may be different from each other.

In an embodiment of the method, the method may further comprise displaying a first visual appearance of at least one of the first object, the second object, and a background in response to the distance between the first part and the second part exceeding the threshold distance, displaying a second visual appearance of at least one of the first object, the second object, and the background in response to the distance between the first part and the second part being within the threshold distance, wherein the first visual appearance and the second visual appearance may be different from each other.

To resolve the technical problems, a method for monitoring a distance between virtual objects and recognizing a contact between virtual objects in a virtual reality environment or an augmented reality environment is performed by a computer device and comprises monitoring a moving velocity of a first part of a first object and a distance between the first part and a second part of a second object, and recognizing that the first object is in contact with the second object when the distance between the first part and the second part is within a threshold distance, wherein the moving velocity of the first part comprises a first direction component and a second direction component, wherein a direction of the moving velocity of the first part is determined based on a ratio of the first direction component to the second direction component, wherein the threshold distance varies based on the ratio.

To resolve the technical problems, a method for monitoring a distance between virtual objects and recognizing a contact between virtual objects in a virtual reality environment or an augmented reality environment is performed by a computer device and comprises monitoring a distance between a first part of a first object and a second part of a second object, and a relative moving speed of the first part with respect to the second part, and recognizing that the first object is in contact with the second object when the distance between the first part and the second part is within a threshold distance, wherein the relative moving speed of the first part is a magnitude of a relative moving velocity of the first part with respect to the second part, wherein the threshold distance varies based on the relative moving speed of the first part while the distance between the first part and the second part is within the threshold distance, wherein the threshold distance is set to an initial value when the distance between the first part and the second part exceeds the threshold distance.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 2B are diagrams illustrating a prior art for implementing a contact between virtual objects in a virtual space;

FIGS. 3A to 4B are diagrams for describing the problems of the prior art shown in FIGS. 1 to 2B;

FIGS. 5A to 6C are diagrams illustrating an exemplary method of setting a threshold distance for recognizing a virtual object and a contact between the virtual objects, according to some embodiments of the present disclosure;

FIGS. 7A to 8B are diagrams illustrating a method of changing a threshold distance based on a moving length or a moving speed of a part of a virtual object according to some embodiments of the present disclosure;

FIGS. 9A to 10B are diagrams illustrating a method of stably maintaining contact between virtual objects by deforming a shape of a virtual object based on a moving length or a moving speed of a part of the virtual object according to some embodiments of the present disclosure;

FIG. 11 is a diagram for describing an embodiment, in which virtual objects becomes into a contact state from a non-contact state by a change in a threshold distance;

FIGS. 12 to 15 are diagrams for describing various embodiments of deriving a moving length or moving speed between parts of virtual objects;

FIG. 16 is a diagram for describing a problem, in which contact between virtual objects and recognizing the contact becomes unstable when there is an instantaneous transition of a threshold distance;

FIG. 17 is a diagram illustrating a relational function for solving the instability of the contact and the recognizing the contact described in FIG. 16 and response characteristics accordingly;

FIG. 18 is a diagram illustrating a method of determining a direction of a moving velocity of a part of an object based on direction components of the moving velocity of the part of the object;

FIG. 19 is a diagram for describing an example of a virtual object;

FIG. 20 is a diagram illustrating a method of displaying a visual appearance of a virtual object according to a change in a distance between virtual objects according to an embodiment of the present disclosure;

FIGS. 21 to 24C are diagrams illustrating still other methods of displaying a visual appearance of a virtual object according to a change in a distance between virtual objects according to other embodiments of the present disclosure;

FIGS. 25 to 32 are flowcharts illustrating a method of monitoring a distance between virtual objects and recognizing a contact between virtual objects in a virtual reality environment or an augmented reality environment according to some embodiments of the present disclosure; and

FIG. 33 is a diagram illustrating an embodiment of recognizing a contact between virtual objects using a touch point of a virtual object according to the present disclosure.

FIG. 34 is a hardware configuration diagram of an exemplary computing device, in which various embodiments of the present disclosure may be implemented.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various embodiments of the present disclosure for solving the above-described technical problem will be described.

The present disclosure is configured to be suitable for a technology for monitoring a distance between virtual objects implemented in a virtual reality or augmented reality environment and recognizing a contact between virtual objects. For example, using the present disclosure, a user may perform a virtual input operation such as virtual drawing, virtual writing, virtual drag, virtual touch, or virtual keyboard typing on virtual reality or augmented reality. However, embodiments of the present disclosure are not necessarily limited to interfaces between virtual objects. That is, the method of monitoring the distance between objects according to the present disclosure is applicable when both objects are virtual objects, one of the two objects is a real object and the other is a virtual object, or both objects are real objects, respectively.

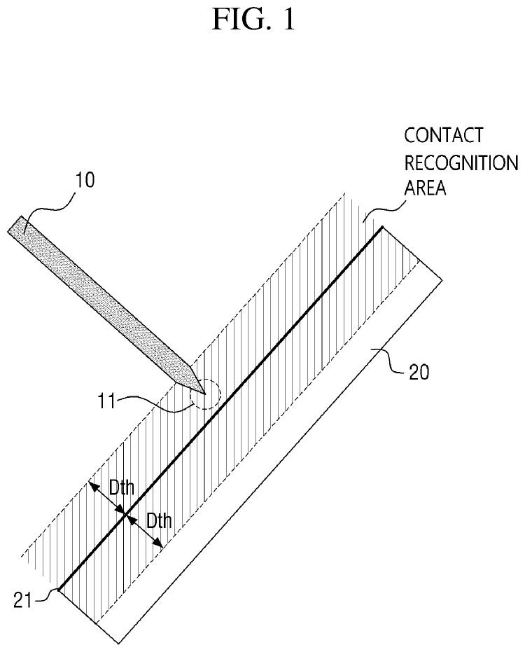

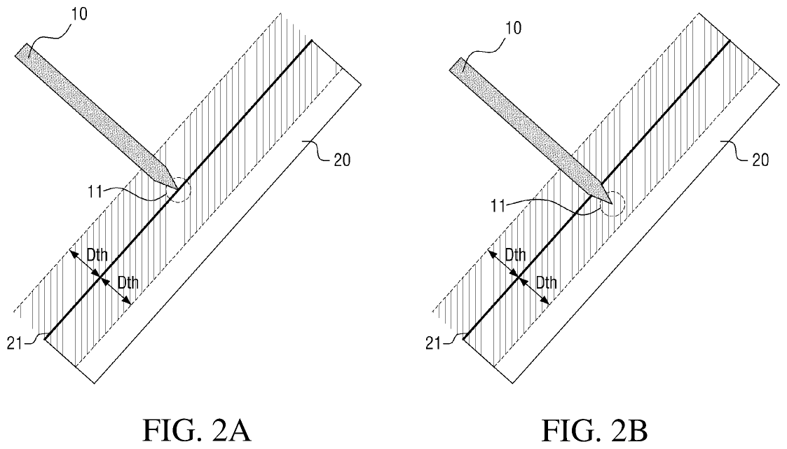

FIGS. 1 to 2B are diagrams illustrating a prior art for implementing a contact between virtual objects in a virtual space.

In general, in order for a virtual reality (hereinafter referred to as ‘VR’) or augmented reality (hereinafter referred to as ‘AR’) user to smoothly interact with a virtual object in a virtual environment, it is necessary to monitor the distance between virtual objects and clearly recognize the contact between virtual objects. In particular, in order to perform virtual drawing, virtual writing, or virtual drag that require continuous contact among interactions in a virtual space, it is necessary to accurately monitor the distance between virtual objects and recognize and control the contact between virtual objects.

In order to monitor the distance between virtual objects and recognize the contact, in the prior art, a method, in which it is recognized that contact between virtual objects has occurred when the distance between virtual objects is within a threshold distance, is used.

FIG. 1 shows a plurality of virtual objects 10 and 20 located on a virtual space. In the prior art, the distance between the first part 11 of the first virtual object 10 and the second part 21 of the second virtual object 20 is monitored for contact recognition between the virtual objects 10 and 20. And, if the distance between the first part 11 and the second part 21 is within a predetermined threshold distance (Dth), it is recognized that a contact has occurred between the first object 10 and the second object 20, even if the first object 10 and the second object 20 does not actually contact each other in a virtual space. That is, by considering the area extended by the threshold distance (Dth) from the second part 21 as the contact recognition area, the contact of the virtual objects is recognized based on a more relaxed standard than the actual contact. Throughout this, the problem in that it was difficult to accurately detect the contact between virtual objects on a virtual space is compensated. The contact recognition area may be set not only between the first part 11 and the second part 21, but also may be set on the surface of the second part 21 or inside the second object 20. For example, referring to FIG. 2A, a case, in which the first part 11 abuts the surface of the second part 21, is illustrated. Referring to FIG. 2B, a case of the first part 11 penetrating into the interior of the second object 20 is shown. In both cases, since the first part 11 is located within a threshold distance (Dth) from the second part 21, it is recognized that the first object 10 and the second object 20 are in contact with each other.

As the first reference patent, U.S. patent application Ser. No. 15/607,276, “Using tracking to simulate direct tablet interaction in mixed reality” describes such a prior art method well. The first reference patent discloses a technique, in which a distance between interacting virtual objects acts as a trigger for activating a task in a virtual space. In the first reference patent, when the distance between the interacting virtual objects is within the threshold distance, it corresponds to the pressing of the contact-type operation button, and when the distance is outside the threshold distance, it corresponds to the release of the contact-type operation button. This corresponds to determining whether the first virtual object 10 and the second virtual object 20 are in contact or non-contact according to whether the distance between the virtual objects 10 and 20 is within a threshold distance (Dth) in FIG. 1.

As a second reference patent, U.S. patent application Ser. No. 16/012,072, “Interaction system for augmented reality objects” discloses an augmented reality system that triggers an animation based on an arrangement of a first virtual object and a second virtual object. In the second reference patent, when the distance between the location of the first virtual object and the location of the second virtual object falls within a threshold distance, a predetermined animation is activated on the virtual space.

As a third reference patent, U.S. patent application Ser. No. 16/531,022, “Augmented reality system and method with dynamic representation technique of augmented images” discloses an augmented reality system, in which the distance between a physical object and a user becomes a trigger for activating a virtual motion in a virtual environment. According to the distance between the physical object and the user, information on the virtual object expressed in the virtual space is dynamically adjusted and displayed to the user using augmented reality glasses. In the third reference patent, unlike the first reference patent or the second reference patent, a threshold distance for triggering a virtual operation is not defined. Instead, in the third reference patent, the distance between the physical object and the user functions as a dial value that determines the continuous characteristic value of the activated virtual motion.

Using such prior art, it is possible to monitor the distance between virtual objects in a virtual reality/augmented reality environment (hereinafter referred to as ‘VR/AR environment’), and recognize that the virtual objects are in contact with each other when the distance between the virtual objects is within a threshold distance. The prior art can sufficiently support it when the trajectory of the virtual input, that is to say, the distance traveled by a virtual object while remaining within the threshold distance from the other virtual object for the virtual input, is short or the progressing speed of the virtual input on the trajectory of the virtual input, that is to say, the moving speed at which the virtual object moves keeping within the threshold distance from the other virtual object for the virtual input, is slow. However, when the trajectory of the virtual input becomes long or the moving speed of the virtual input on the trajectory of the virtual input is fast, there is a problem in that the prior art cannot stably maintain contact between virtual objects, contrary to the intention of the user.

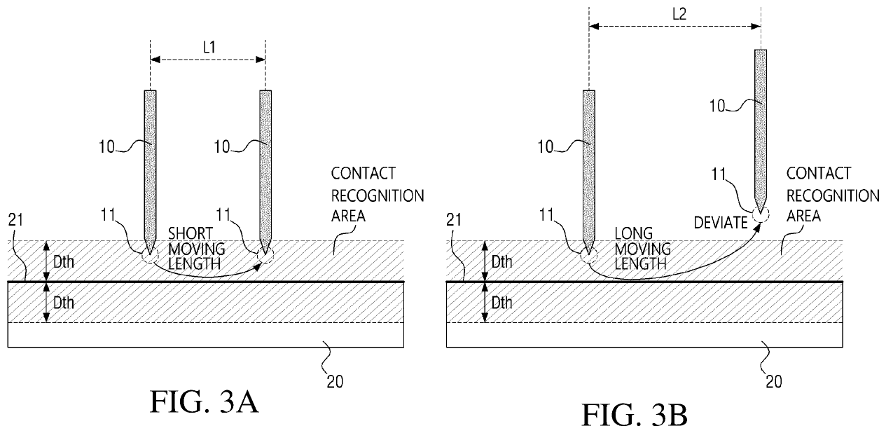

FIGS. 3A and 3B specifically show the limitations of this prior art. In FIG. 3A, as an example of a virtual input, a case, in which a virtual drawing occurs as short as L1 length, is shown. In FIG. 3B, as another example of the virtual input, a case, in which the virtual drawing occurs as long as L2 length, is shown. At this time, L2>>L1.

In FIG. 3A, the virtual drawing occurs by a relatively short length (L1), so it is easy for the user to consistently maintain the first part 11 to be within a threshold distance (Dth) from the second part 21 during the virtual drawing. Accordingly, during the user's virtual drawing, the AR/VR system may recognize that the first object 10 and the second object 20 are in constant contact and perform a virtual operation corresponding thereto.

On the other hand, in FIG. 3B, the virtual drawing occurs by a relatively long length (L2). As the moving length of the first part 11 increases, the instability and irregularity of the moving path of the first part 11 increase. Therefore, it becomes difficult for the user to consistently maintain the first part 11 to be within the threshold distance (Dth) from the second part 21 during the virtual drawing.

For example, even if the first part 11 is within a threshold distance from the second part 21 at the start of the virtual drawing, the first part 11 may be further than the threshold distance from the second part 21 at the middle or end of the virtual drawing. When the first part 11 is further away from the second part 21 than the threshold distance, the AR/VR system recognizes that the first object 10 and the second object 20 are in a non-contact state with each other. Therefore, unlike the user's intention, the virtual drawing is interrupted or stopped. This phenomenon occurs more easily as the length of the trajectory of the virtual input, for example, a virtual drawing, a virtual writing, or a virtual drag, becomes longer.

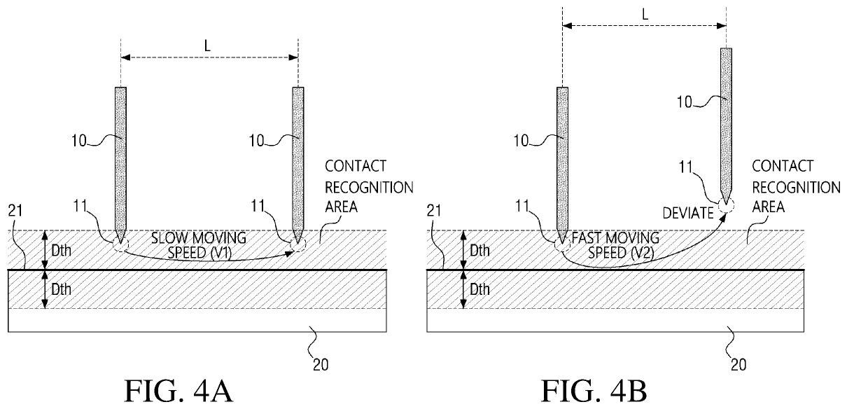

As another example, in FIGS. 4A and 4B, a limitation of the prior art according to a progressing speed on a trajectory of a virtual input is described. FIG. 4A shows a case, in which the virtual drawing slowly occurs at V1 speed. FIG. 4B shows a case, in which virtual drawing occurs rapidly at V2 speed. At this time, V2>>V1, and the length of the virtual drawing is the same as L.

In FIG. 4A, since the virtual drawing occurs at a relatively slow speed (V1), it is easy for the user to consistently maintain a state, in which the first part 11 is within a threshold distance (Dth) from the second part 21 during the virtual drawing. Accordingly, during the user's virtual drawing, the AR/VR system may recognize that the first object 10 and the second object 20 are in constant contact and perform a virtual input operation corresponding thereto.

On the other hand, in FIG. 4B, the virtual drawing occurs at a relatively fast speed (V2). As the moving speed of the first part 11 increases, the instability and irregularity of the moving path of the first part 11 increase. Therefore, it becomes difficult for the user to consistently maintain the state, in which the first part 11 is within the threshold distance (Dth) from the second part 21 during the virtual drawing. For example, even if the first part 11 is within a threshold distance from the second part 21 at the start of the virtual drawing, the first part 11 may be further than the threshold distance from the second part 21 at the middle or end of the virtual drawing. When the first part 11 leaves the contact recognition area, the AR/VR system recognizes that the first object 10 and the second object 20 are in a non-contact state, and thus, unlike the user's intention, a phenomenon, in which the virtual drawing is interrupted or stopped, occurs. This phenomenon occurs more easily as the progressing speed of the virtual input on the trajectory of the virtual input, for example, the speed of virtual drawing, writing, or dragging increases.

As such, the prior art has a problem in that, contrary to the intention of the user, contact between virtual objects cannot be stably maintained when the trajectory of the virtual input becomes long or the progressing speed of the virtual input on the trajectory of the virtual input increases. Accordingly, it may be difficult for the prior art to precisely and accurately recognize the continuous contact that may occur during a virtual input, for example, virtual drawing, virtual writing, or virtual drag, and accordingly, it may be difficult to precisely and accurately control the continuous contact.

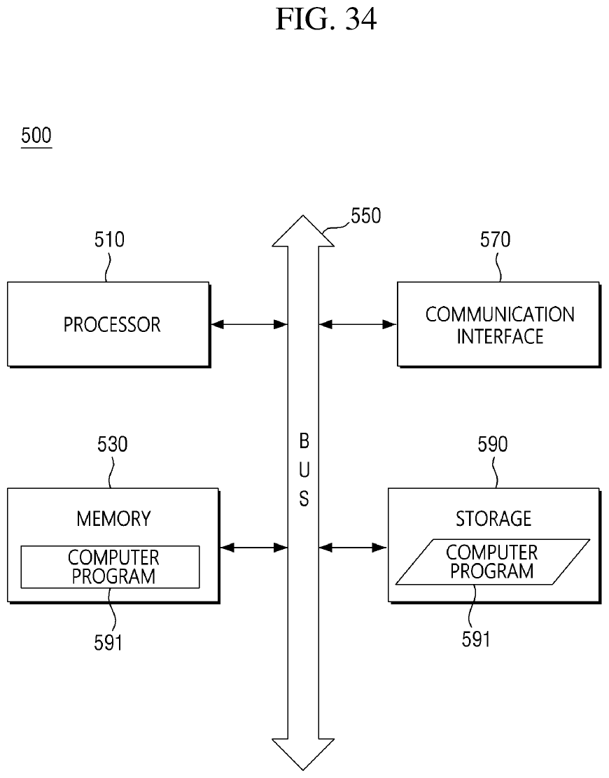

Hereinafter, main technical features of the present disclosure for overcoming the limitations of the prior art described above will be described along with various embodiments. The methods according to the present disclosure described below may be performed by a device that monitors distances between virtual objects and recognizes contact of virtual objects in a virtual reality environment or augmented reality environment that can be implemented with the computing device 500 described in FIG. 34. Therefore, when the subject of the operation is omitted in the following description, it is assumed that the subject is the device.

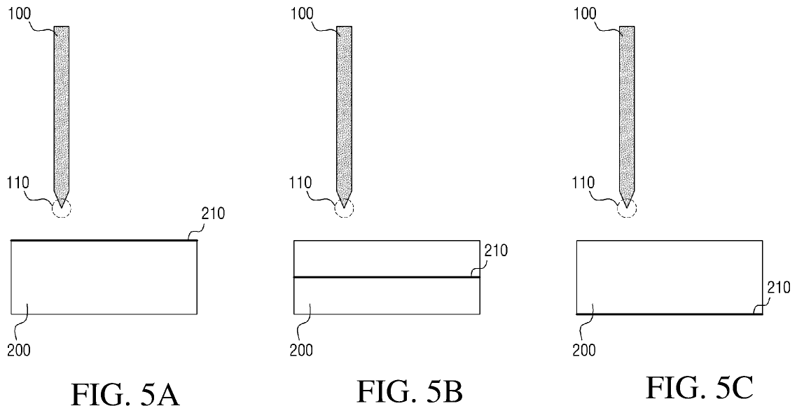

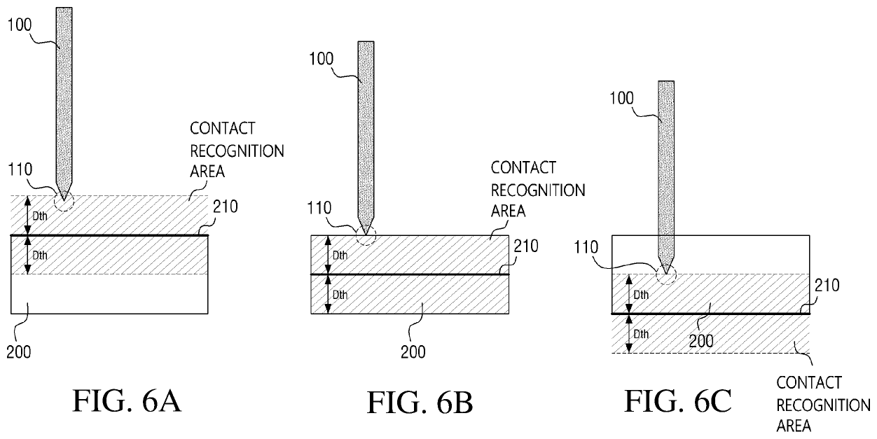

FIGS. 5A to 5C are diagrams illustrating a shape of an exemplary virtual object according to some embodiments of the present disclosure. FIGS. 6A to 6C are diagrams illustrating various formation positions of a threshold distance. At least two objects 100 and 200 may be implemented in the virtual space. As shown in FIGS. 5A to 5C, among them, the first object 100 may be displayed in the form of a pen and the second object 200 may be displayed in the form of a pad. However, such a display form is exemplary, and the scope of the present disclosure is not limited thereto. For example, the first object 100 may be displayed in a different form such as a human hand or a pointer, and the second object 200 may be displayed in a different form such as a notepad, a white board, or a notebook.

In the present disclosure, the distance between the first part 110 of the first object 100 and the second part 210 of the second object is monitored to recognize a contact between the virtual objects 100 and 200, and it may be recognized that the first object 100 and the second object 200 are in contact with each other when the distance between the first part 110 and the second part 210 is within a threshold distance.

As an example, the first part 110 may be a tip of the first object 100.

As an embodiment, the second part 210 may be a surface of the second object 200 as shown in FIG. 5A, or may be an inner cross-section of the second object 200 as shown in FIG. 5B, or a bottom surface of the second object 200 as shown in FIG. 5C.

As an embodiment, a contact recognition area for recognizing a contact between the virtual objects 100 and 200 may be determined based on the position of the second part 210 of the second object 200. For example, when the second part 210 is the surface of the second object 200 as shown in FIG. 6A, the contact recognition area may be determined as an area within a threshold distance (Dth) from the surface of the second object 200. When the second part 210 is the inner cross-section of the second object 200 as shown in FIG. 6B, the contact recognition area may be determined as an area within a threshold distance (Dth) from the inner cross-section of the second object 200. When the second part 210 is the bottom surface of the second object 200 as shown in FIG. 6C, the contact recognition area may be determined as an area within a threshold distance (Dth) from the bottom surface of the second object 200.

As an embodiment, the second part 210 may be a part of the second object 200, such as the first part 110 of the first object 100, not a surface of the second object 200.

In each case, if the first part 110 of the first object 100 is located within the contact recognition area, that is, if the distance between the first part 110 and the second part 210 is within a threshold distance, it is recognized that the first object 100 and the second object 200 are in contact with each other.

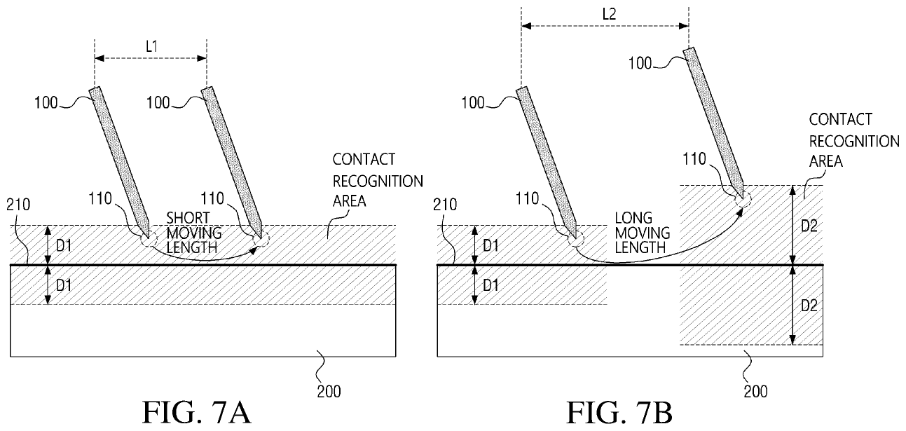

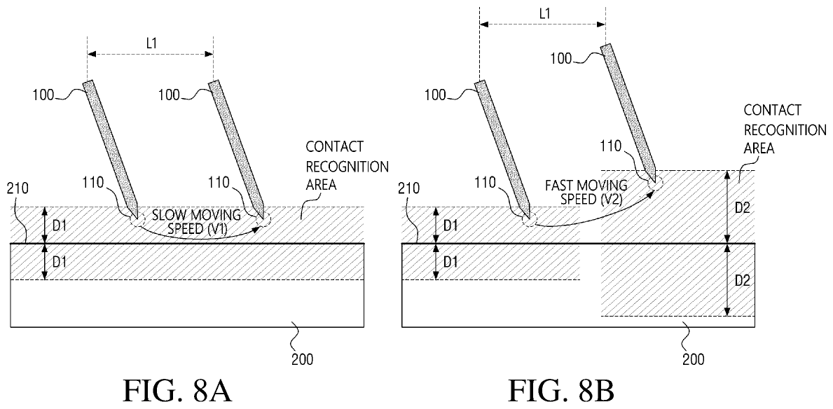

FIGS. 7A and 8B are diagrams illustrating a method of changing a threshold distance based on a moving length or a moving speed of a part of a virtual object according to some embodiments of the present disclosure.

As described above, the longer the trajectory of the virtual input or the faster the progressing speed of the virtual input on the trajectory of the virtual input, the greater the instability and irregularity of the moving path of the first part 110, so that it becomes difficult to maintain the first part 110 to be within the contact recognition area from the second part 210. Accordingly, in the present embodiment, a method of monitoring a moving length and a moving speed of a part of a virtual object, or a distance between virtual objects and changing a threshold distance based on the moving length, the moving speed, or the distance is proposed. In this case, the monitored object may be, for example, a moving length of the first part 110, a moving speed of the first part 110, or a distance between the first part 110 and the second part 210.

Referring to FIG. 7A, a case, in which the moving length (L1) of the first part 110 is short, is illustrated. When the moving length is short, the threshold distance is maintained at D1 as in the initial stage. If the moving length is short, the instability and irregularity of the moving path of the first part 110 are small, so even if the threshold distance is maintained at D1, the probability of the first part 110 unintentionally deviating from the contact recognition area is low.

Meanwhile, referring to FIG. 7B, a case, in which the moving length (L2) of the first part 110 is long, is illustrated. When the moving length is long, the threshold distance is adjusted to a threshold distance (D2) that is longer than the initial threshold distance (D1). If the moving length is long, the instability and irregularity of the moving path of the first part 110 increase. In this case, if the threshold distance is maintained at D1, the probability of the first part 110 unintentionally deviating from the contact recognition area increases. Accordingly, when the moving length increases, the threshold distance is increased from D1 to D2 correspondingly, thereby preventing the first part 110 from unintentionally deviating from the contact recognition area.

As an embodiment, when the moving length of the first part 110 decreases, the threshold distance may be correspondingly decreased. Even though the moving length decrease, if the threshold distance when the moving length is long is maintained, the contact recognition area is formed wider than necessary, and unintended contact and contact recognition may occur. Therefore, in order to prevent this, when the moving length of the first part 110 decreases, the threshold distance is decreased to correspond thereto.

Similarly, the threshold distance may vary based on the moving speed of the first part 110. Referring to FIG. 8A, a case, in which the moving speed (V1) of the first part 110 is slow, is illustrated. When the moving speed is slow, the threshold distance is maintained at D1 as in the initial stage. If the moving speed is slow, the instability and irregularity of the moving path of the first part 110 are small, so even if the threshold distance is maintained at D1, the probability of the first part 110 unintentionally deviating from the contact recognition area is low.

On the other hand, referring to FIG. 8B, a case, in which the moving speed (V2) of the first part 110 is fast, is shown. The moving length of the first part 110 is L1 as the same as in the case of FIG. 8A. When the moving speed is fast, the threshold distance is adjusted to a threshold distance (D2) that is longer than the initial threshold distance (D1). If the moving speed is fast, the instability and irregularity of the moving path of the first part 110 increase. Therefore, if the threshold distance is maintained at D1, the probability of the first part 110 unintentionally deviating from the threshold distance increases. Accordingly, when the moving speed is fast, the threshold distance is increased from D1 to D2 correspondingly, thereby preventing the first part 110 from unintentionally deviating from the contact recognition area.

As an embodiment, when the moving speed of the first part 110 decreases, the threshold distance may be correspondingly decreased. Even if the moving speed is decreased, if the threshold distance when the moving speed is high is maintained, the contact recognition area is formed wider than necessary, and unintended contact and contact recognition may occur. Therefore, in order to prevent this, when the moving speed of the first part 110 decreases, the threshold distance is decreased to correspond thereto.

In the embodiments of FIGS. 5A to 8B, the threshold distance may be changed or determined based on a relational function having a moving length or a moving speed of the first part 110 as a parameter.

The relational function may be determined in various forms. For example, the relational function may be in the form of Equation 1.

Dth=Dini+fa(L)=Dini+h1(e^{a*(L-L}^{ₜₕ}⁾−1)+(h2(L−Lₜₕ))ⁿ [Equation 1]

Where Dth is the threshold distance,

Dini is the initial value of the threshold distance,

fa(L) is a first relational function and is a function having a moving length of the first part 110 as a parameter, provided that fa(L)=0 when L<Lth,

L is the moving length of the first part 110,

Lth is a predetermined threshold length,

a, h1 and h2 are predetermined coefficients,

n is a natural number.

As an example, the Lth may be 0.

As an example, the a may be 0.

As an example, the h1 may be 0.

As an example, the h2 may be 0.

As another example, the relational function may be in the form of Equation 2.

Dth=Dini+fb(S)=Dini+h1(e^{a*(S-S}^{ₜₕ}⁾−1)+(h2(S−Sₜₕ))ⁿ [Equation 2]

Where Dth is the threshold distance,

Dini is the initial value of the threshold distance,

fb(S) is a second relational function and a function having the moving speed of the first part 110 as a parameter, provided that fb(S)=0 when S<Sth,

S is the moving speed of the first part 110,

Sth is a predetermined threshold speed,

a, h1 and h2 are predetermined coefficients,

n is a natural number.

As an example, the Sth may be 0.

As an example, the a may be 0.

As an example, the h1 may be 0.

As an example, the h2 may be 0.

As another example, the relational function is a function having the moving length (L) and the moving speed (S) of the first part 110 as independent variables, and may be in the form of Equation 3.

Dth=Dini+fa(L)=Dini+h1(e^{a*(S-S}^{ₜₕ}⁾−1)+(h2(L−Lₜₕ))ⁿ [Equation 2]

Where Dth is the threshold distance,

Dini is the initial value of the threshold distance,

fa(L) is a first relational function and is a function having a moving length of the first part 110 as a parameter, provided that fa(L)=0 when L<Lth,

fb(S) is a second relational function and a function having the moving speed of the first part 110 as a parameter, provided that fb(S)=0 when S<Sth,

L is the moving length of the first part 110,

Lth is a predetermined threshold length,

S is the moving speed of the first part 110,

Sth is the predetermined threshold speed,

a, h1 and h2 are predetermined coefficients,

n is a natural number.

As an example, the Lth may be 0.

As an example, the Sth may be 0.

As an example, the a may be 0.

As an example, the h1 may be 0.

As am example, the h2 may be 0.

So far, some examples of the relational function have been presented in Equations 1 to 3, but the scope of the present disclosure is not limited thereto. Any function having a moving length or moving speed of the first part 110 as a parameter may be applied as the relational function.

Alternatively, the relational function may be derived by a deep learning algorithm such as a convolution neural network (CNN).

In embodiments of FIGS. 5A to 8B, when the distance between the first part 110 of the first object 100 and the second part 210 of the second object 200 exceeds a threshold distance, that is, when the first part 110 is out of the contact recognition area, the threshold distance may be initialized to an initial value. As described above, the threshold distance may be increased or decreased based on the moving length or moving speed of the first part 110. In this case, when the distance between the first part 110 and the second part 210 exceeds the threshold distance, the increased or decreased threshold distance may be initialized to an initial value as the user's virtual input is considered to have ended.

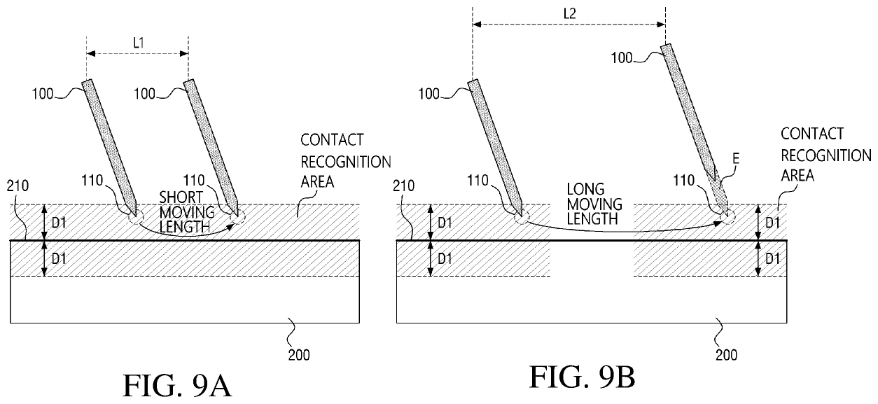

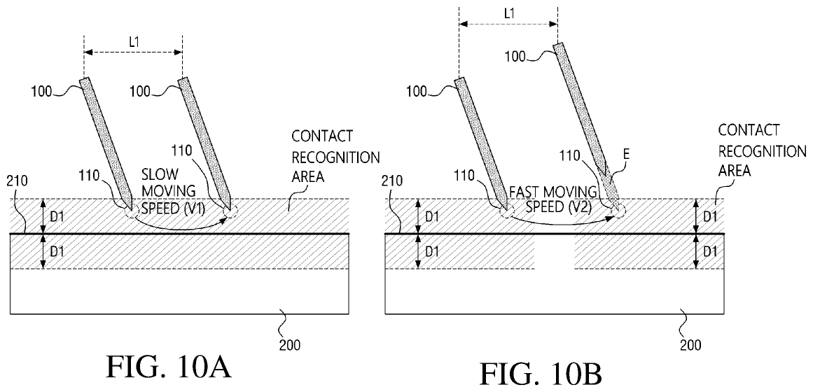

As an embodiment, instead of increasing or decreasing the threshold distance according to the moving length or moving speed of the first part 110 of the first object 100, the shape of the first object 100 or the second object 200 may be deformed. For a detailed description of this, reference is made to FIGS. 9A to 10B.

Referring to FIGS. 9A and 9B, an embodiment, in which the shape of the first object 100 is deformed based on the moving length of the first part 110, is illustrated. As mentioned above, as the length of the virtual input increases, the instability and irregularity of the moving path of the first part 110 increase, so that it becomes difficult that the first part 110 is within the contact recognition area from the second part 210. In FIGS. 9A to 9B, instead of increasing the threshold distance when the moving length of the first part 110 increases, an embodiment, in which the shape of the first object 100 is deformed so that the length of a part of the first object 100 increases, is described.

In FIG. 9A, when the moving length (L1) of the first part 110 is short, the probability that the first part 110 deviates from the threshold distance, which is the contact recognition area, is not high, so the threshold distance is maintained at D1 as in the initial stage. Even if the shape of the first object 100 is not deformed, the first part 110 may stably stay within the contact recognition area from the second part 210.

In FIG. 9B, when the moving length (L2) of the first part 110 is long, the probability that the first part 110 deviates from the threshold distance, which is the contact recognition area, increases. Therefore, a means is needed to maintain the first part 110 within the contact recognition area from the second part 210. As such a means, increasing the threshold distance as described in FIG. 7 is also applicable, but in FIG. 9B, a method of maintaining the threshold distance at D1 but deforming E the shape of the first object 100 so as to extend a part of the first object 100 in order for the first part 110 to stay within the contact recognition area is proposed. As the moving length increases, the instability and irregularity of the moving path of the first part 110 increase, so it becomes difficult that the first part 110 is within the contact recognition area from the second part 210, but the first part 110 can stably stay within the contact recognition area by deforming the shape of the first object 100 to extend the first part 110.

As an example, when the moving length of the first part 110 decreases from a long state, the shape of the first object 100 may be deformed to reduce the length of a part of the first object 100. As the moving length decreases, the instability and irregularity of the moving path of the first part 110 decreases. Therefore, when the moving length of the first part 110 decreases, the probability that the first part 110 deviates from the threshold distance, which is the contact recognition area, decreases, so the shape of the first object 100 is deformed to reduce the length of a part of the first object 100 while maintaining the threshold distance at D1 so that the first part 110 can stably stay in the contact recognition area.

Referring to FIGS. 10A and 10B, an embodiment, in which the first object 100 is deformed based on the moving speed of the first part 110, is illustrated. Similar to the embodiment of FIGS. 9A and 9B, in FIGS. 10A and 10B, instead of increasing the threshold distance when the moving speed of the first part 110 increases, the first object 100 is deformed so as to increase the length of a part of the first object 100.

In FIG. 10A, a case where the moving speed (V1) of the first part 110 is slow (V1<V2), for example, a case where the moving speed (V1) is less than the threshold speed (Sth) is shown. In this case, since the probability that the first part 110 deviates from the threshold distance, which is the contact recognition area, is not high, the threshold distance is maintained at D1 as in the initial stage, and even if the shape of the first object 100 is not deformed, the first part 110 can stably stay within the contact recognition area from the second part 210.

FIG. 10B shows a case where the moving speed (V2) of the first part 110 is relatively high (V1<V2). In this case, since the probability that the first part 110 deviates from the threshold distance, which is the contact recognition area, increases, a means for maintaining the first part 110 within the contact recognition area from the second part 210 is necessary. As such a means, it is also applicable to increase the threshold distance as described in FIGS. 8A and 8B, but in FIG. 10B, a method of maintaining the threshold distance at D1 but deforming E the shape of the first object 100 so as to extend a part of the first object 100 so that the first part 110 stays within the contact recognition area is proposed. As the moving speed increases, the instability and irregularity of the moving path of the first part 110 increase, so it becomes difficult that the first part 110 is within the contact recognition area from the second part 210, but the first part 110 can stably stay within the contact recognition area by deforming the shape of the first object 100 to extend a part of the first object 100.

As an example, when the moving speed of the first part 110 decreases from the state that the moving speed is high, the shape of the first object 100 may be deformed to reduce the length of a part of the first object 100. When the moving speed of the first part 110 decreases, the instability and irregularity of the moving path of the first part 110 decreases. Therefore, when the moving speed of the first part 110 decreases, the shape of the first object 100 is deformed to reduce the length of a part of the first object 100 while maintaining the threshold distance at D1, so that the first part 110 can stably stay within the contact recognition area.

Meanwhile, in FIGS. 9A to 10B, a case where the shape of the first object 100 is deformed based on the moving length or moving speed of the first part 110 is illustrated, but the scope of the present disclosure is not limited thereto. For example, instead of deforming the shape of the first object 100, it is possible to deform the shape of the second object 200. When the moving length or moving speed of the first part 110 increases, the shape of the second object 200 is deformed to increase the length of a part of the first object 100 and to extend the second part 210, so that the first part 110 can stably stay within the contact recognition area without deforming the shape of the first object 100.

In the embodiments of FIGS. 9A to 10B, when the distance between the first part 110 of the first object 100 and the second part 210 of the second object 200 exceeds a threshold distance, that is, when the first part 110 is out of the contact recognition area, the deformed shape of the first object 100 or the second object 200 may be initialized to the original shape. For example, when the shape of the first object 100 is deformed based on the moving length or the moving speed of the first part 110, and the shape of the first object 100 is deformed to extend or reduce first part 110, when the distance between the first part 110 and the second part 210 exceeds the threshold distance, the deformed shape of the first object 100 may be initialized to its original shape, assuming that the virtual input by the user has ended.

In the embodiments of FIGS. 9A to 10B, the degree, to which the first object 100 is deformed based on the movement of the first part 110, may be determined based on a relational function. As the relational function at this time, any one of the relational functions described in Equations 1 to 3 above, or any relational function having a moving length or moving speed of the first part 110 as a parameter may be applied. In this case, the threshold distance (Dth) in Equations 1 to 3 becomes a deformed dimension of the first object 100 or the second object 200, for example, the extended length of a part of the first object 100 or a part of the second object 200, and the initial value (Dini) of the threshold distance becomes the initial dimension of the first object 100 or the second object 200, for example, the initial length of the first object 100 or the second object 200.

As an embodiment, the extended length of the first part 110 may be a deformed dimension in the threshold distance direction or the second part direction, and the extended length of the second part 210 may be a deformed dimension in the first part direction.

As an embodiment, the deformed part of the first object 100 or the second object 200 may be invisible. That is, the shape of the first object 100 may be deformed to extend or reduce the length of a part of the first object 100 in an invisible form while maintaining the appearance before the shape of the first object 100 or the second object 200 is deformed.

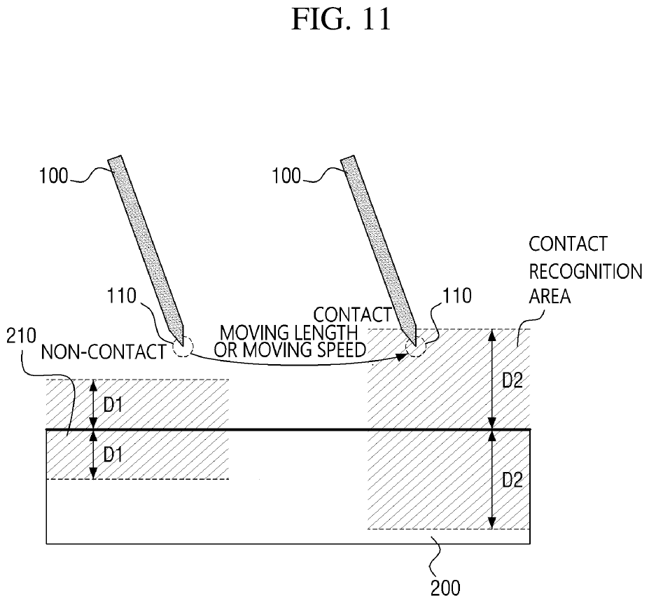

As an embodiment, the threshold distance may be changed even when the first object 100 and the second object 200 are not in the contact state. An embodiment in this regard will be described with reference to FIG. 11.

In FIG. 11, when a virtual input is started, the first part 110 is located outside the threshold distance (D1) from the second part 210, and the first object 100 is in a non-contact state with the second object 200. When the virtual input proceeds, the moving length or moving speed of the first part 110 is monitored, and the threshold distance increases from D1 to D2 according to the increase of the moving length or moving speed of the first part 110. As the threshold distance increases, the distance between the first part 110 and the second part 210 becomes within the threshold distance, and the first object 100 and the second object 200 are recognized as being in contact with each other. In this way, even if the first object 100 and the second object 200 are in a non-contact state when the virtual input is started, the threshold distance changes according to the moving length or moving speed of the first part 110 while the virtual input is in progress. Accordingly, the first object 100 and the second object 200 become into a contact state, and the first object 100 and the second object 200 may be recognized as being in contact. That is, the change in the threshold distance based on the moving length or the moving speed of the first part 110 may occur regardless of whether the first part 110 is currently within the threshold distance from the second part 210.

Meanwhile, in FIG. 11, a case where the threshold distance changes regardless of whether the first part 110 is within the threshold distance from the second part 210 is shown, but a similar principle can be applied to the embodiments of FIGS. 9A to 10B. In other words, even if the first object 100 and the second object 200 are in a non-contact state when the virtual input is started, the shape of the first object 100 or the second object 200 is deformed to extend or reduce the length of a part of the first object 100 or the second object 200 according to the moving length or the moving speed of the first part 110, and accordingly, the first object 100 and the second object 200 becomes in a contact state, and the first object 100 and the second object 200 may be recognized as being in contact.

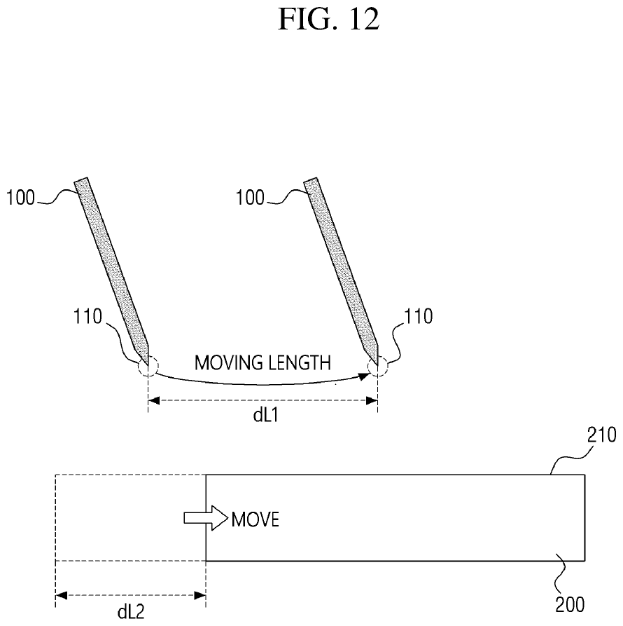

As an embodiment, the moving length of the first part 110 that is the basis for the change of the threshold distance may be a relative moving length of the first part 110 with respect to the second part 210. An embodiment in this regard will be described with reference to FIG. 12.

Referring to FIG. 12, an embodiment, in which the second part 210 of the second object 200 moves while the first part 110 of the first object 100 moves, is illustrated. The first part 110 of the first object 100 moves in a first direction by a first moving length (dL1), and the second part 210 of the second object 200 moves in a first direction by a second moving length (dL2). However, it is assumed that dL1>dL2. In this case, the relative moving length of the first part 110 with respect to the second part 210 is (dL1-dL2), and the relative moving length may be the moving length of the first part 110 that is the basis of the threshold distance change.

As an embodiment, the moving speed of the first part 110 that is the basis of the threshold distance change may be a relative moving speed of the first part 110 with respect to the second part 210. In this case, the relative moving speed may be a magnitude of a relative moving velocity of the first part 110 with respect to the second part 210. For example, the first part 110 of the first object 100 moves in the first direction at the first moving speed (dV1), and the second part 210 of the second object 200 moves in the first direction at the second moving speed (dV2), and it is assumed that dV1>dV2. In this case, the relative moving speed of the first part 110 with respect to the second part 210 is (dV1-dV2), and the relative moving speed may be the moving speed of the first part 110 that is the basis of the threshold distance change.

Meanwhile, in FIG. 12, a case, in which the moving direction of the first part 110 and the moving direction of the second part 210 are the same, is illustrated, but the scope of the present disclosure is not limited thereto. When the moving direction of the first part 110 and the moving direction of the second part 210 do not match, the relative moving length or the relative moving speed of the first part 110 with respect to the second part 210 may be defined.

As an example, it is assumed that the first part 110 of the first object 100 moves as much as the first moving vector (P1), and the second part 210 of the second object 200 moves as much as the second moving vector (P2), and the direction of the first moving vector (P1) and the direction of the second moving vector (P2) are different from each other. In this case, the relative moving length of the first part 110 with respect to the second part 210 becomes the magnitude of the vector (P1-P2) obtained by subtracting the second moving vector (P2) from the first moving vector (P1), and the threshold distance may vary based on the relative moving length.

As another example, it is assumed that the first part 110 of the first object 100 moves at the first moving velocity (Q1), and the second part 210 of the second object 200 moves at the second moving velocity (Q2), and the direction of the first moving velocity (Q1) and the direction of the second moving velocity (Q2) are different from each other. In this case, the relative moving speed of the first part 110 with respect to the second part 210 becomes the magnitude of the vector (Q1-Q2) obtained by subtracting the second moving velocity (Q2) from the first moving velocity (Q1), and the threshold distance may vary based on the relative moving speed. The vector (Q1-Q2) is the relative moving velocity of the first part 110 with respect to the second part 210.

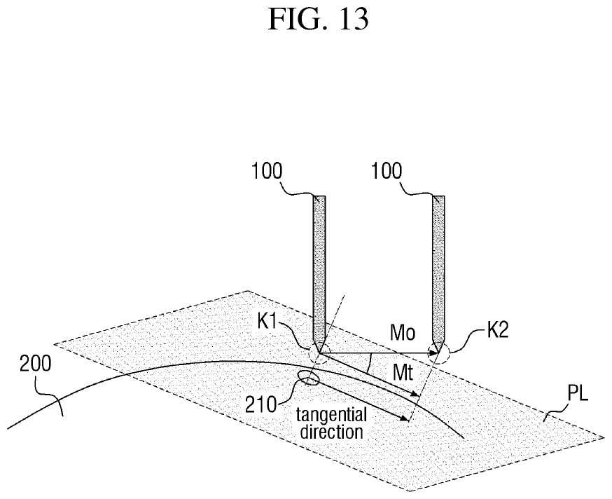

As an embodiment, when the surface of the second object 200 is not flat, the moving length or moving speed of the first part 110, which is the basis of the threshold distance change, may be the magnitude of a tangential direction component at the point where the first part 110 of the first object 100 is projected perpendicular to the second part 210 of the moving vector or the moving velocity of the first part 110 of the first object 100. Referring to FIG. 13, an example, in which the surface of the second object 200 is not flat and the first part of the first object 100 moves from the first position (K1) to the second position (K2), is illustrated. In this case, the moving vector of the first part is Mo, but the magnitude of Mt, which is a tangential direction component of the second part 210 of the direction components constituting the movement vector Mo, becomes the moving length of the first part that is the basis of the threshold distance change. Alternatively, when the moving vector Mo represents the moving velocity of the first part, the magnitude of the tangential direction component Mt becomes the moving speed of the first part, which is the basis of the threshold distance change. In this case, the tangential direction is a direction parallel to the tangent plane (PL) of the second part 210 at the point where the first part is projected perpendicular to the second part 210.

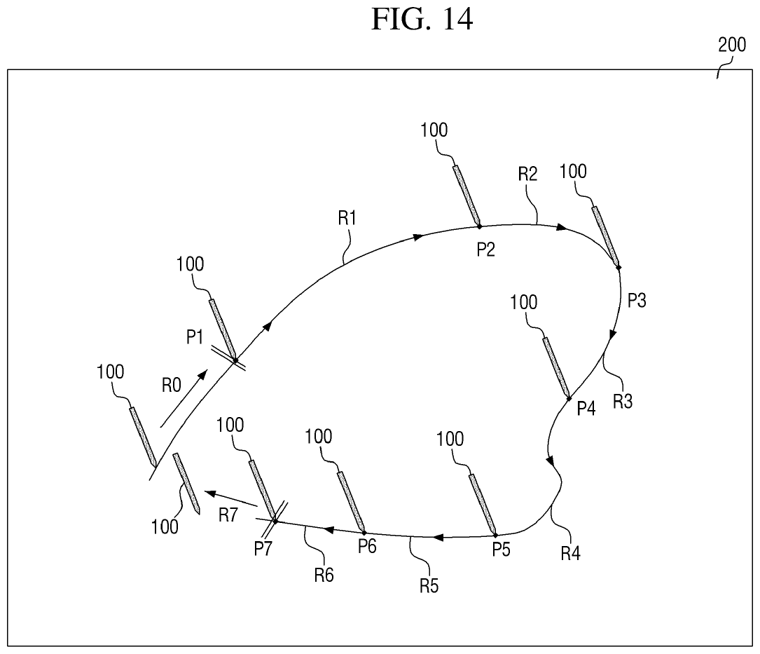

In one embodiment, the threshold distance is changed based on the moving length or the moving speed of the first part 110 of the first object 100, but the threshold distance can be changed only while the moving speed of the moving object 100 is equal to or greater than the threshold speed. In this case, if the moving speed of the first part 110 of the first object 100 is less than the threshold speed, the threshold distance may be initialized to an initial value. As an embodiment, the threshold speed may be zero or a real number greater than zero. An embodiment in this regard will be described with reference to FIG. 14.

FIG. 14 illustrates an example, in which the first part 110 of the first object 100 moves sequentially through P1, P2, P3, P4, P5, P6, and P7. In the embodiment of FIG. 14, the threshold distance is changed only while the first part 110 of the first object 100 moves at a moving speed equal to or greater than the threshold speed. If the moving speed of the first part 110 of the first object 100 is less than the threshold speed, the threshold distance may be initialized to an initial value. In FIG. 14, it is assumed that the moving speed of the first part 110 of the first object 100 in the 0th path (R0) and the 7th path (R7) is less than the threshold speed, and the moving speed of the first part 110 of the first object 100 in the first path (R1), the second path (R2), the third path (R3), the fourth path (R4), the fifth path (R5), and the sixth path (R6) is equal to or greater than the threshold speed.

In the 0th path (R0), since the moving speed of the first part 110 of the first object 100 is less than the threshold speed, the threshold distance is determined as an initial value and the threshold distance does not change.

In the first path (R1) to the sixth path (R6), since the moving speed of the first part 110 of the first object 100 is equal to or greater than the threshold speed, the threshold distance changes based on the moving length or moving speed of the first part 110 of the first object 100.

For example, the threshold distance may be changed based on the moving length of the first part 110 of the first object 100 from P1 to P7.

Alternatively, the threshold distance may be changed based on the moving speed of the first part 110 of the first object 100 from P1 to P7. In this case, the moving speed of the first part 110 of the first object 100 may be a magnitude of an instantaneous linear velocity of the first part 110 of the first object 100. Alternatively, the moving speed of the first part 110 of the first object 100 may be a value obtained by dividing the moving length of the first part 110 of the first object 100 moving on the first path (R1) to the sixth path (R6) by the time taken for the movement.

In the seventh path (R7), since the moving speed of the first part 110 of the first object 100 is less than the threshold speed, the threshold distance returns to an initial value. In the seventh path (R7), the threshold distance does not change based on the moving length or the moving speed of the first part 110 of the first object 100.

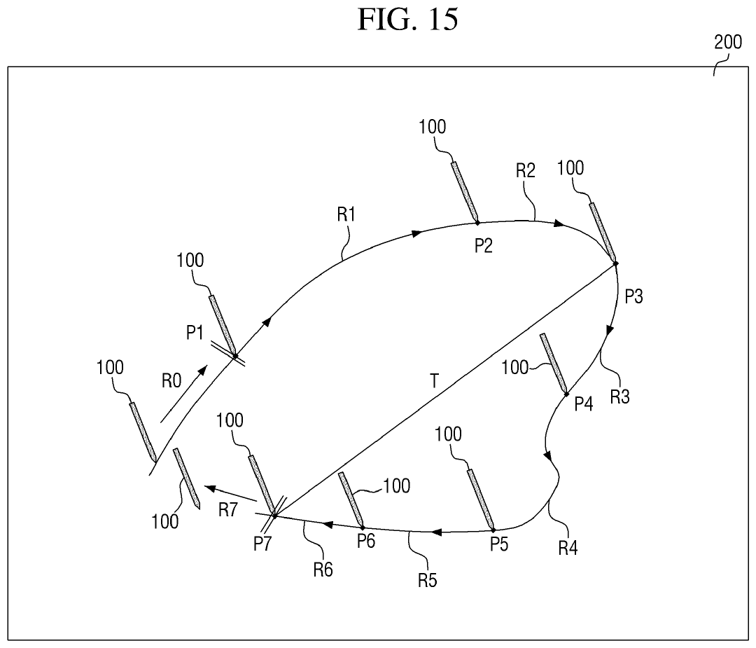

As an embodiment, the moving length of the first part 110 of the first object 100, which is the basis of the threshold distance change, may be the length of the path, in which the first part 110 of the first object 100 moves between two points on the path in which the first part 110 of the first object 100 moves at a moving speed equal to or greater than the threshold speed. In this case, the two points may be two points having the longest straight distance among points on the path where the first part 110 of the first object 100 has moved. An embodiment in this regard will be described with reference to FIG. 15.

Similar to FIG. 14, FIG. 15 shows an example, in which the first part 110 of the first object 100 moves sequentially through P1, P2, P3, P4, P5, P6, and P7. In the embodiment of FIG. 15, the threshold distance is changed only while the first part 110 of the first object 100 moves at a moving speed equal to or greater than the threshold speed. If the moving speed of the first part 110 of the first object 100 is less than the threshold speed, the threshold distance may be initialized to an initial value. In FIG. 15, it is assumed that the moving speed of the first part 110 of the first object 100 on the 0th path (R0) and the 7th path (R7) is less than the threshold speed, and the moving speed of the first part 110 of the first object 100 on the first path (R1), the second path (R2), the third path (R3), the fourth path (R4), the fifth path (R5), and the sixth path (R6) is equal to or greater than the threshold speed.

In the embodiment of FIG. 15, instead of the length of the path, in which the first part 110 of the first object 100 actually moves, the distance between the two points among points on the path, in which the first part 110 of the first object moves at a moving speed equal to or greater than the threshold speed may be used as the moving length of the first part 110 of the first object 100, which is the basis of the threshold distance change. In this case, the two points may be two points having the longest straight distance among points on the path where the first part 110 of the first object 100 has moved.

For example, when the first part 110 of the first object 100 passes from the first path (R1) to the sixth path (R6) and is located at a point P7, among points on the path from the first path (R1) to the sixth path (R6), the two points with the longest straight distance among points on the path from the first path (R1) to the sixth path (R6) are P3 and P7. In this case, T, which is a straight distance between P3 and P7 on the path from the first path (R1) to the sixth path (R6), may be used as the moving length of the first part 110 of the first object 100, which is the basis of the threshold distance change. Alternatively, the length of the entire path (R3 to R6) that the first object 100 has moved between the two points P3 and P7 may be used as the moving length of the first part 110 of the first object 100, which is the basis of the threshold distance change.

Meanwhile, in the embodiment of FIG. 15, the straight distance between the starting point P1 and the arrival point among points on the path where the first part 110 of the first object 100 has moved while maintaining equal to or greater than the threshold speed may be used as the moving length of the first part 110 of the first object 100, which is the basis of the threshold distance change.

As an embodiment, in the embodiment of FIG. 14 or 15, instead of changing the threshold distance based on the moving length or moving speed of the first part 110 of the first object 100, the shape of the first object 100 or the second object 200 may be deformed as described above with reference to FIGS. 9A to 10B.

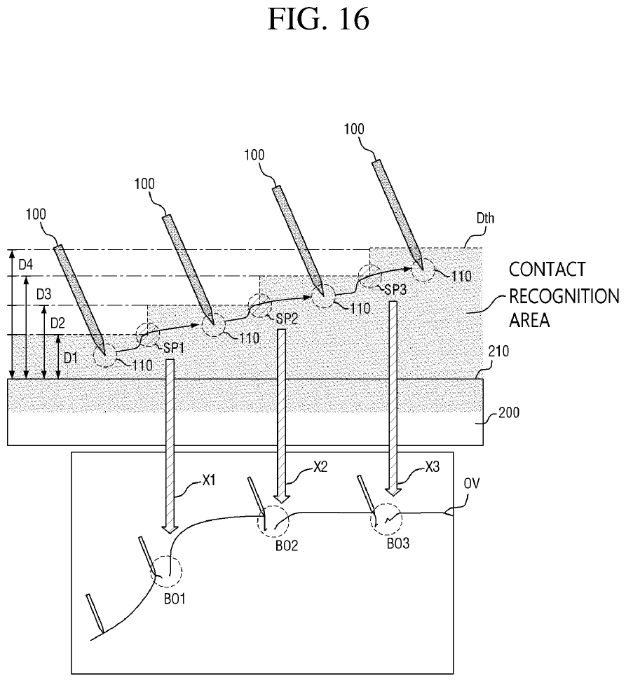

FIG. 16 is a diagram for describing a problem, in which contact between virtual objects and recognizing the contact becomes unstable when there is an instantaneous transition of a threshold distance. In FIG. 16, it is assumed that the threshold distance (Dth) varies according to the moving length or the moving speed of the first part 110, and the value of the threshold distance (Dth) varies stepwise from D1 to D4 according to the moving length or moving speed of the first part 110 as shown in FIG. 16. That is, it is assumed that the relational function determining the threshold distance (Dth) is in the form of a step function. At this time, points (SP1, SP2, and SP3) near portions where the value of the threshold distance (Dth) suddenly transits, contact between virtual objects and recognizing the contact may become unstable. This is because when the moving trajectory of the first part 110 indicated by one solid arrow in FIG. 16 passes near the transition portions (SP1, SP2, and SP3), the distance between the first part 110 and the second part 210 may be instantaneously larger than the threshold distance and then smaller again, and it is recognized that the first object 100 and the second object 200 are not in contact with each other in a section, in which the distance is larger than the threshold distance.

This instability of contact recognition is a phenomenon that occurs because the value of the threshold distance (Dth) instantaneously transits. If the relational function is set to a function without such a transition section, the instability of contact between virtual objects and recognizing the contact can be eliminated.

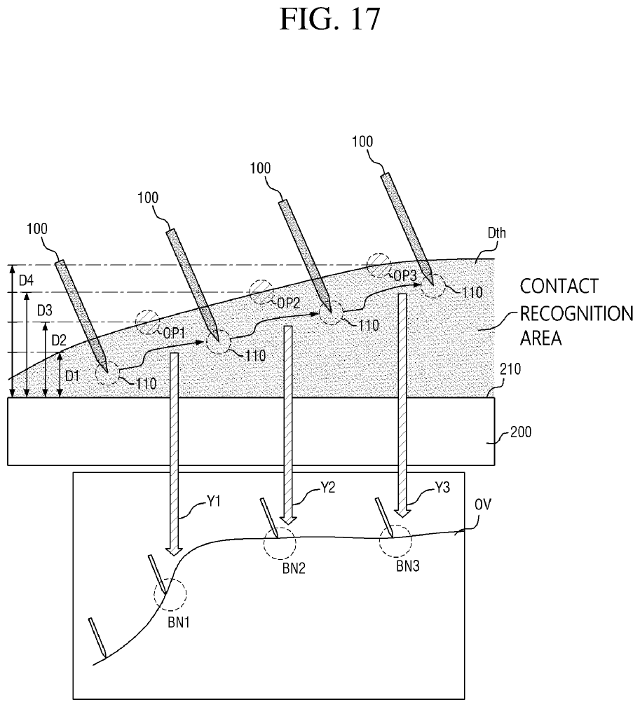

FIG. 17 is a diagram illustrating a relational function capable of solving the instability of contact between virtual objects and recognizing the contact described in FIG. 16 and response characteristics accordingly. In the embodiment of FIG. 17, an exemplary relational function is assumed to be a function having a gentle slope without an instantaneous transition section of the threshold distance (Dth). These relational functions may be exponential functions, logarithmic functions, first-order linear functions, multi-order functions, other non-linear functions, or combinations thereof. For example, the relational function may be any one of the relational functions described in Equations 1 to 3 above.

In this case, the graph of the threshold distance (Dth) has a smooth shape without an instantaneous transition section, as shown in FIG. 17. That is, even at points (OP1, OP2, OP3) where the threshold distance (Dth) changes to D2, D3, or D4, the distance between the first part 110 and the second part 210 is stably maintained within the threshold distance (Dth), contact between virtual objects and recognizing the contact can be stably performed (BN1, BN2, BN3) when there is the virtual input (OV).

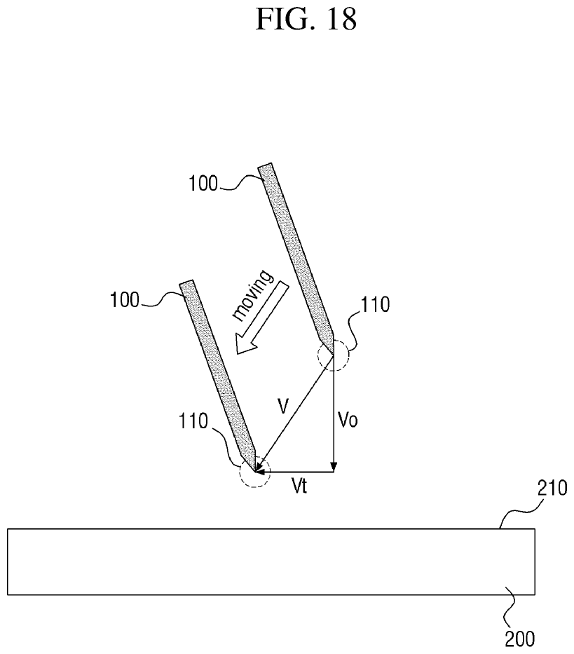

FIG. 18 shows an embodiment, in which the threshold distance changes based on a direction of a moving velocity of a part of an object. In FIG. 18, it is assumed that the first part 110 of the first object 100 moves at the velocity (V), and the velocity (V) of the first part 110 comprises a first direction component (Vo) and a second direction component (Vt). Here, the first direction component (Vo) may be a normal direction component of the second part 210 of the second object 200, and the second direction component (Vt) may be a tangential direction component of the second part 210 of the second object 200.

At this time, the direction of the moving velocity of the first part 110 is determined based on a ratio of the first direction component (Vo) to the second direction component (Vt), and the threshold distance may change based on the determined direction of the moving velocity. In this case, when the ratio of the first direction component (Vo) to the second direction component (Vt) increases, the threshold distance increases correspondingly, and when the ratio of the first direction component (Vo) to the second direction component (Vt) decreases, the threshold distance can also decrease correspondingly. Alternatively, as a complementary example, when the ratio of the first direction component (Vo) to the second direction component (Vt) increases, the threshold distance may also decrease correspondingly, and when the ratio of the first direction component (Vo) to the second direction component (Vt) decreases, the threshold distance may also increase correspondingly.

As an embodiment, the threshold distance can change based on the ratio of the first direction component (Vo) to the second direction component (Vt) only under the condition that the ratio of the first direction component (Vo) to the second direction component (Vt) is equal to or greater than the threshold ratio. In this case, if the ratio of the first direction component (Vo) to the second direction component (Vt) is less than the threshold ratio, the threshold distance may be initialized to an initial value.

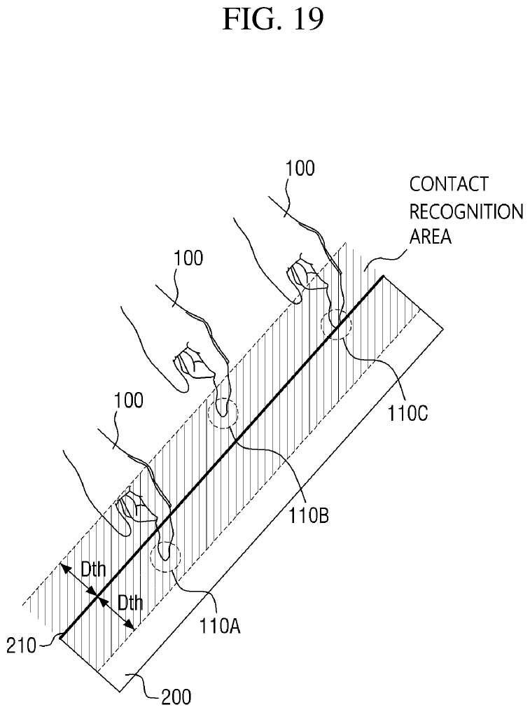

Meanwhile, as mentioned above, the first object 100 is not necessarily limited to a rigid body such as a virtual interface. For example, as illustrated in FIG. 19, the first object 100 may be a deformable body such as an actual hand of a user.

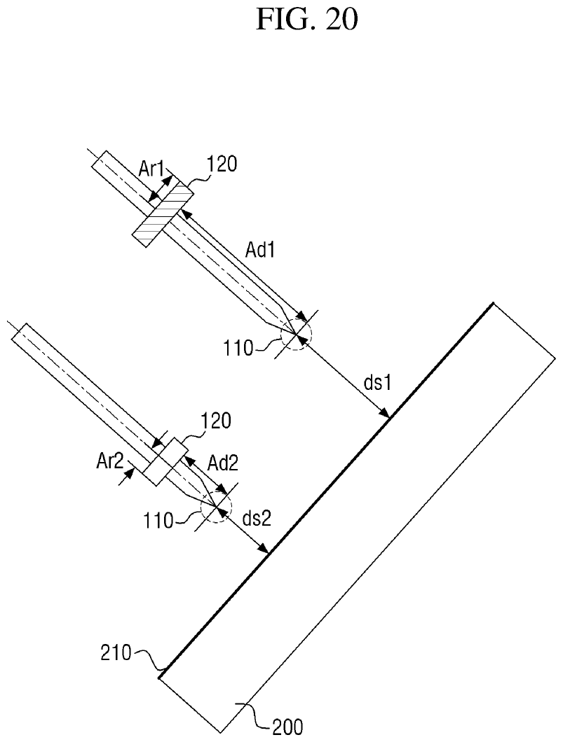

In FIGS. 20 to 24C, a method of changing a visual appearance of a virtual object according to a change in a distance between virtual objects is described. In FIGS. 20 to 24C, visual appearances of at least one of the first object 100, the second object 200, or a background are displayed when the distance between the virtual objects changes. It will be described below with reference to the drawings.

In FIG. 20, a visual appearance 120 is displayed on the first object 100. As the visual appearance 120, the shape or color of a part of the first object 100 is displayed differently as the distance between the first part 110 and the second part 210 changes. For example, when the distance between the first part 110 and the second part 210 is ds1, the visual appearance 120 is displayed as a visual appearance with a radius of Ar1 and located at a distance by Ad1 from the end point of the first part 110. On the other hand, when the distance between the first part 110 and the second part 210 is changed to ds2, the visual appearance 120 is changed to a second visual appearance with a radius of Ar2 and located at a distance by Ad2 from the end point of the first part 110 and displayed. Alternatively, when the distance between the first part 110 and the second part 210 is changed, the color of the visual appearance 120 may be changed from the first color to the second color.

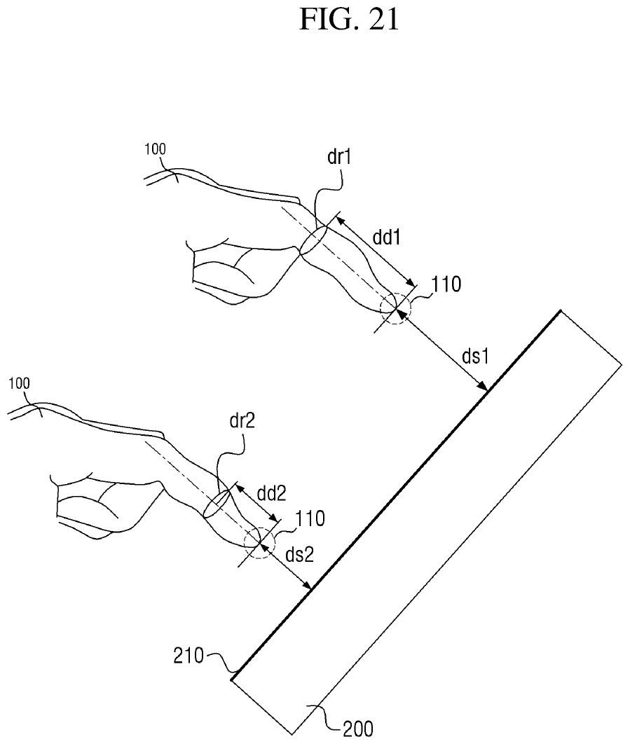

In FIG. 21, an example, in which the color or shape of the inner cross section or the inner volume of the first object 100 is changed as a visual appearance according to a change in the distance between the first part 110 and the second part 210, is shown. Referring to FIG. 21, when the distance between the first portion 110 and the second portion 210 is ds1, the visual appearance is displayed as an inner cross section (dr1) located at a distance by dd1 from the end point of the first part 110. On the other hand, when the distance between the first part 110 and the second part 210 changes to ds2, the visual appearance is changed to another inner cross section (dr2) located at a distance by dd2 from the end point of the first part 110 and displayed. In this case, the change in the visual appearance may be accompanied by a change in shape and color of the inner cross sections (dr1 and dr2).

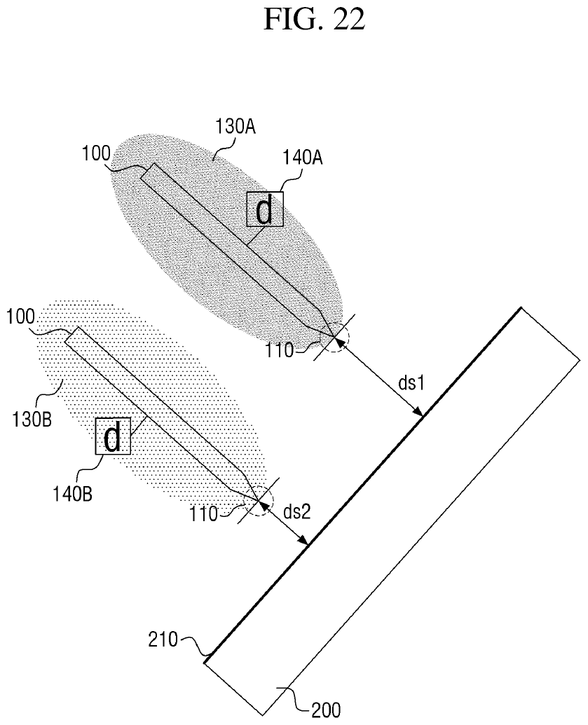

In FIG. 22, an example, in which the visual appearance of a background of the first object 100 is changed according to a change in the distance between the first part 110 and the second part 210, is shown. Referring to FIG. 22, when the distance between the first part 110 and the second part 210 is ds1, the visual appearance is displayed as a background 130A of the first color around the first object 100. In addition, when the distance between the first part 110 and the second part 210 changes to ds2, the visual appearance is changed to a background 130B of the second color around the first object 100 and displayed. In this case, the visual appearance may include one or more signs or symbols 140A and 140B displayed together with the backgrounds 130A and 130B. As an embodiment, the one or more signs or symbols 140A and 140B may be connected to a part of the first object 100 by a lead line, or may be disposed or displayed on a part of the surface or inside the first object 100. When the one or more signs or symbols 140A, 140B are disposed inside the first object 100, at least a part of the first object 100 may be displayed as translucent or transparent in order to secure visibility of the one or more signs or symbols 140A, 140B.

In FIGS. 20 to 22, only the case of displaying the visual appearance of the first object 100 according to the change in the distance between the first part 110 and the second part 210 has been described, but it is also possible to display a visual appearance of the second object 200 according to the change in the distance between the first part 110 and the second part 210 in the same manner.

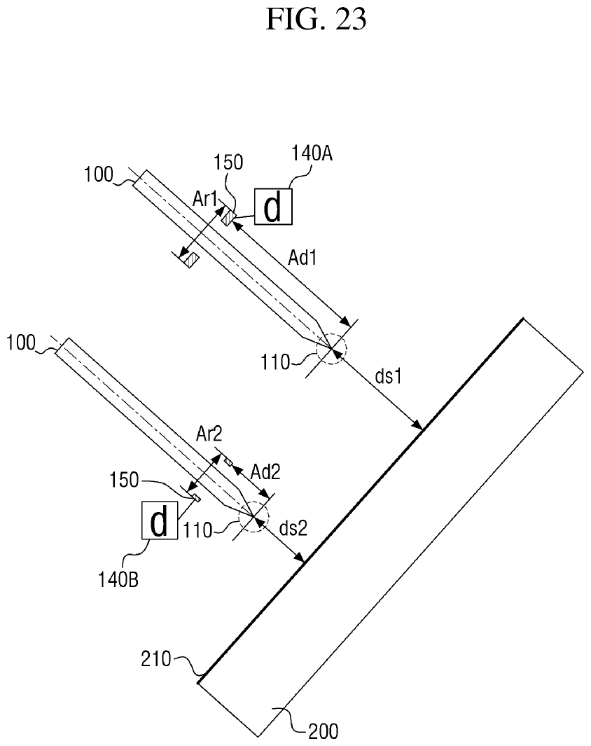

FIG. 23 shows another example, in which the visual appearance of a background of the first object 100 is changed according to a change in the distance between the first part 110 and the second part 210. As the visual appearance of the background of the first object 100, an example, in which the visual appearance of the third object 150 other than the first object 100 and the second object 200 changes according to a change in distance between the first part 110 and the second part 210, is shown. In FIG. 23, when the distance between the first part 110 and the second part 210 is ds1, the visual appearance of the third object 150 is displayed as the first visual appearance, which has an outer diameter of Ar1 and is located at a distance by Ad1 from an end point of the first part 110. On the other hand, when the distance between the first part 110 and the second part 210 changes to ds2, the visual appearance of the third object 150 is changed to a second visual appearance, which has an outer diameter of Ar2 and is located at a distance by Ad2 from the end point of the first part 110, and displayed. As an embodiment, the visual appearance of the third object 150 may be displayed together with one or more signs or symbols 140A and 140B. As an embodiment, when the distance between the first part 110 and the second part 210 changes, the color of the third object 150 may be changed from the first color to the second color as the visual appearance.

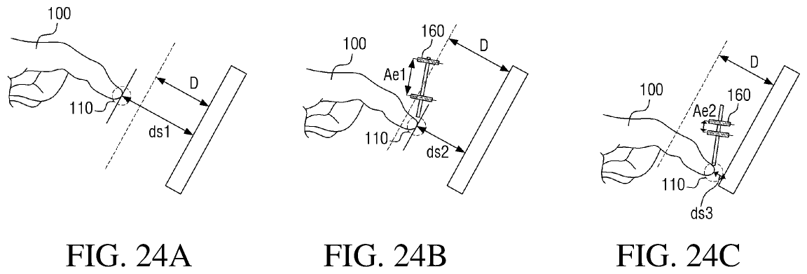

FIGS. 24A to 24C illustrates another example, in which the visual appearance of a background of the first object 100 is changed according to a change in the distance between the first part 110 and the second part 210. As the visual appearance of the background of the first object 100, an embodiment, in which according to a change in the distance between the first part 110 and the second part 210, a virtual object that did not previously exist is created in the background of the first object 100 or the second object 200, and the visual appearance of the created virtual object is displayed differently, is illustrated.

In FIG. 24A, when the distance (ds1) between the first part 110 and the second part 210 is greater than the predetermined reference distance (D), the visual appearance different from the existing one is not displayed in the background around the first object 100 thereof. In FIG. 24B, when the distance (ds2) between the first part 110 and the second part 210 is within the reference distance (D), a virtual object that did not previously exist is created and its visual appearance 160 is displayed in the background around the first object 100. The visual appearance 160 may include two disks separated by Ae1. In FIG. 24C, when the distance (ds3) between the first part 110 and the second part 210 becomes smaller within the reference distance (D), the visual appearance 160 of the background around the first object 100 is changed and displayed in a different form. For example, the change of the visual appearance 160 may be displayed in the form of reducing the distance between the two disks to Ae2.

Meanwhile, so far, although the case where the visual appearance of at least one of the first object 100, the second object 200, and the background is changed and displayed based on the change in the distance between the first part 110 and the second part 210 has been described, the scope of the present disclosure is not limited thereto. For example, when the distance between the first part 110 and the second part 210 changes, generating a sound or haptic stimulus, or changing the intensity or frequency of the sound or haptic stimulus may be performed independently or in parallel with a change and display of the visual appearance.

The user may more easily recognizes the change in the distance between the first part 110 and the second part 210 by sensing the change in the visual appearance, the change in the sound stimulus, or the change in the haptic stimulus based on the change in the distance between the first part 110 and the second part 210.

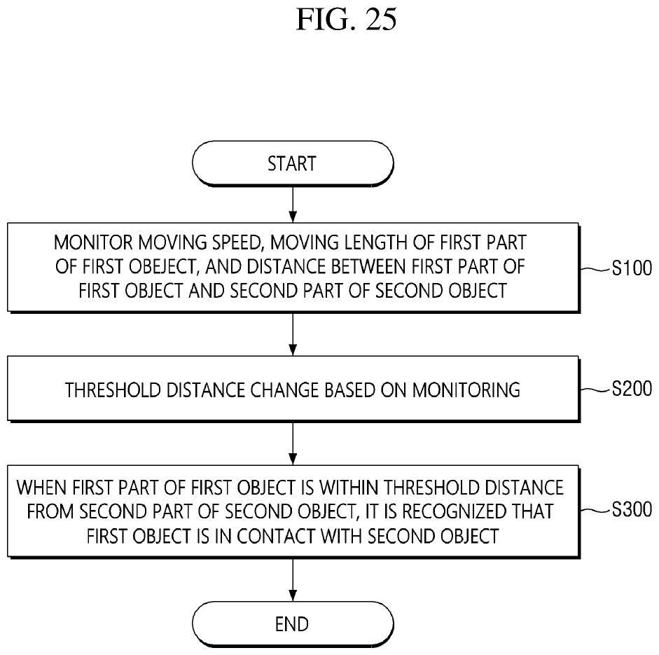

FIGS. 25 to 32 are flowcharts illustrating exemplary embodiments of the present disclosure described so far. The methods of FIGS. 25 to 32 may be performed by a device that can be implemented with the computing device 500 of FIG. 34. Therefore, if the performing subject is omitted in the following steps, it is assumed that the performing subject is the device. In the embodiments of FIGS. 25 to 32, content overlapping with the previously described content will be omitted for simplicity of description.

FIG. 25 is a flowchart illustrating a method of monitoring a distance between virtual objects and recognizing a contact of virtual objects in a virtual reality environment or an augmented reality environment according to some embodiments of the present disclosure.

In step S100, the moving speed of the first part of the first object, the moving length of the first part of the first object, or the distance between the first part of the first object and the second part of the second object are monitored.

In step S200, the threshold distance is changed based on the monitoring result.

As an embodiment, the threshold distance is changed based on the moving length of the first part, and the moving length of the first part may be a moving length during the first part moves from a first point to a second point while maintaining a moving speed equal to or greater than a threshold speed.

As an embodiment, the threshold distance is changed based on the direction of the moving velocity of the first part, the moving velocity of the first part comprises a first direction component and a second direction component, and the direction of the moving velocity of the first part may be determined based on a ratio of the first direction component to the second direction component.

As an embodiment, the threshold distance is changed based on the moving speed of the first part, and the moving speed of the first part may be the magnitude of the linear velocity at the moment the first part moves, or may be a value obtained by dividing the moving length by the time taken to the movement.

In one embodiment, the threshold distance is changed based on the relative moving length of the first part with respect to the second part, and the relative moving length may be the magnitude of a vector derived by subtracting the moving vector of the second part from the moving vector of the first part.

As an embodiment, the threshold distance is changed based on the relative moving speed of the first part with respect to the second part, and the relative moving speed may be the magnitude of a vector derived by subtracting the moving velocity of the second part from the moving velocity of the first part.

In step S300, when the distance between the first part and the second part is within a threshold distance, it is recognized that the first object is in contact with the second object.

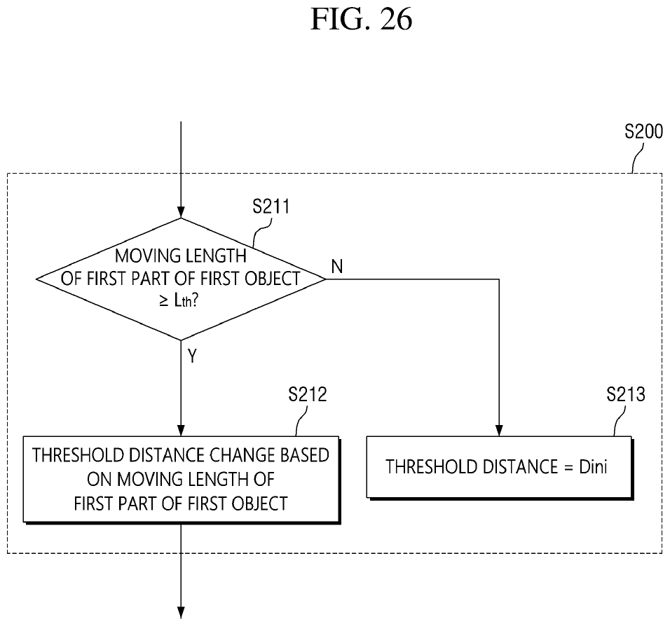

FIG. 26 is a flowchart illustrating an exemplary embodiment, in which step S200 of FIG. 25 is further embodied. In FIG. 26, an embodiment, in which the threshold distance changes based on the moving length of the first part of the first object, will be described.

In step S211, it is determined whether the moving length of the first part of the first object is greater than or equal to the threshold length (Lth). If the moving length of the first part of the first object is greater than or equal to the threshold length (Lth), the present embodiment proceeds to step S212, and the threshold distance is changed based on the moving length of the first part of the first object. On the other hand, if the moving length of the first part of the first object is less than the threshold length (Lth), the present embodiment proceeds to step S213, and the threshold distance is initialized to an initial value (Dini). In this case, the threshold length (Lth) may be 0.

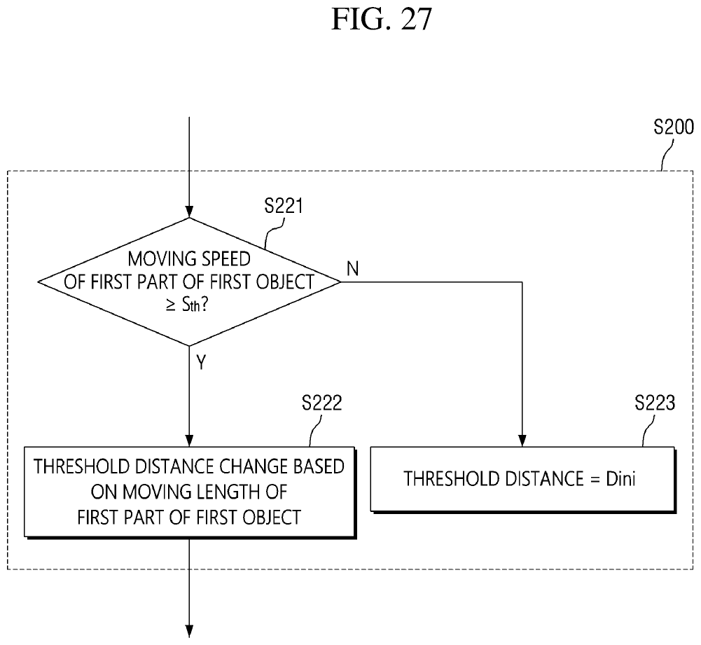

FIG. 27 is a flowchart illustrating another embodiment, in which step S200 of FIG. 25 is further embodied. In FIG. 27, an embodiment, in which the threshold distance changes based on the moving speed of the first part of the first object, will be described.

In step S221, it is determined whether the moving speed of the first part of the first object is greater than or equal to the threshold speed (Sth). If the moving speed of the first object or the first part is greater than or equal to the threshold speed (Sth), the present embodiment proceeds to step S222, and the threshold distance is changed based on the moving speed of the first part of the first object. On the other hand, if the moving speed of the first part of the first object is less than the threshold speed (Sth), the present embodiment proceeds to step S223, and the threshold distance is initialized to an initial value (Dini). In this case, the threshold speed (Sth) may be 0.

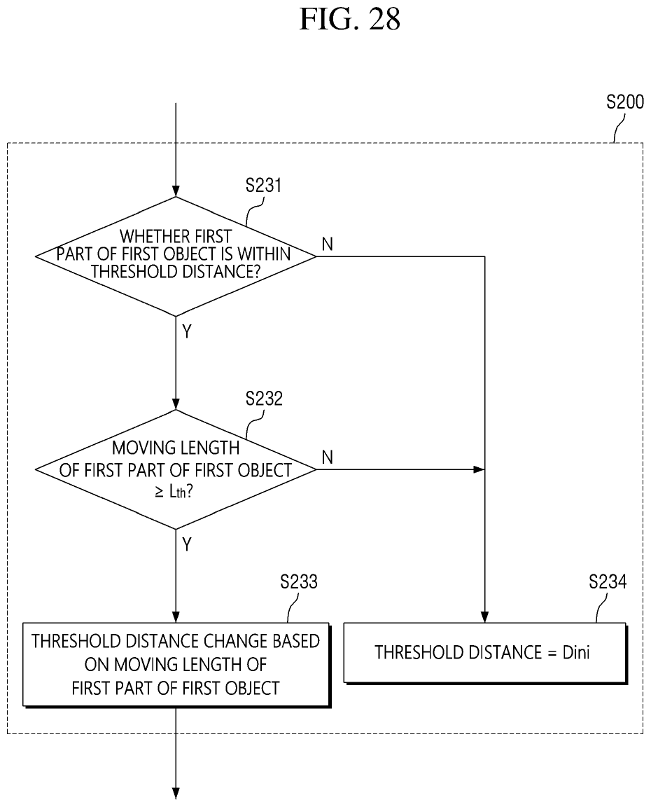

FIG. 28 is a flowchart illustrating another embodiment, in which step S200 of FIG. 25 is further embodied. In FIG. 28, the threshold distance is changed based on the moving length of the first part of the first object, and the threshold distance is changed under the condition that the first part of the first object is within the threshold distance from the second part.

In step S231, it is determined whether the first part of the first object is within a threshold distance (Dth) from the second part. If the first part is within the threshold distance (Dth) from the second part, the present embodiment proceeds to step S232, and it is determined whether the moving length of the first part of the first object is greater than or equal to the threshold length (Lth). If the moving length of the first part of first object is greater than or equal to the threshold length (Lth), the present embodiment proceeds to step S233 again, and the threshold distance is changed based on the moving length of the first part of the first object. On the other hand, if the moving length of the first part of the first object is less than the threshold length (Lth), the present embodiment proceeds to step S234, and the threshold distance is initialized to an initial value (Dini). In this case, the threshold length (Lth) may be 0.

On the other hand, returning to step S231, if the first part is outside the threshold distance (Dth) from the second part, the present embodiment proceeds to step S234, and the threshold distance is initialized to an initial value (Dini).

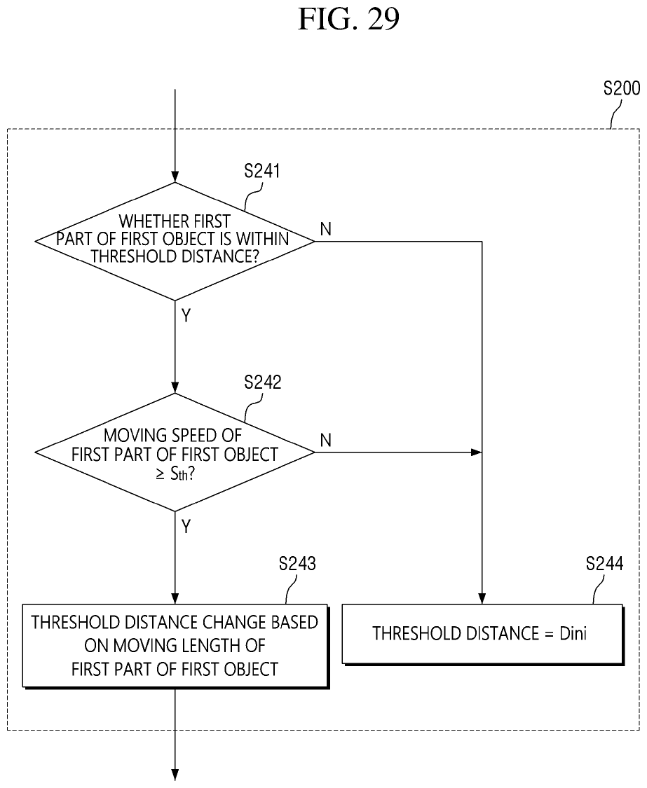

FIG. 29 is a flowchart illustrating another embodiment, in which step S200 of FIG. 25 is further embodied. In FIG. 29, the threshold distance is changed based on the moving speed of the first part of the first object, and the threshold distance is changed under the condition that the first part of the first object is within the threshold distance from the second part.

In step S241, it is determined whether the first part of the first object is within a threshold distance (Dth) from the second part. If the first part is within the threshold distance (Dth) from the second part, the present embodiment proceeds to step S242, and it is determined whether the moving speed of the first part of the first object is equal to or greater than the threshold speed (Sth). If the moving speed of the first part of the first object is greater than or equal to the threshold speed (Sth), the present embodiment proceeds to step S243 again, and the threshold distance is changed based on the moving speed of the first part of the first object. On the other hand, if the moving speed of the first part of the first object is less than the threshold speed (Sth), the present embodiment proceeds to step S244, and the threshold distance is initialized to an initial value (Dini). In this case, the threshold speed (Sth) may be 0.

On the other hand, returning to step S241, if the first part is outside the threshold distance (Dth) from the second part, the present embodiment proceeds to step S244, and the threshold distance is initialized to an initial value (Dini).

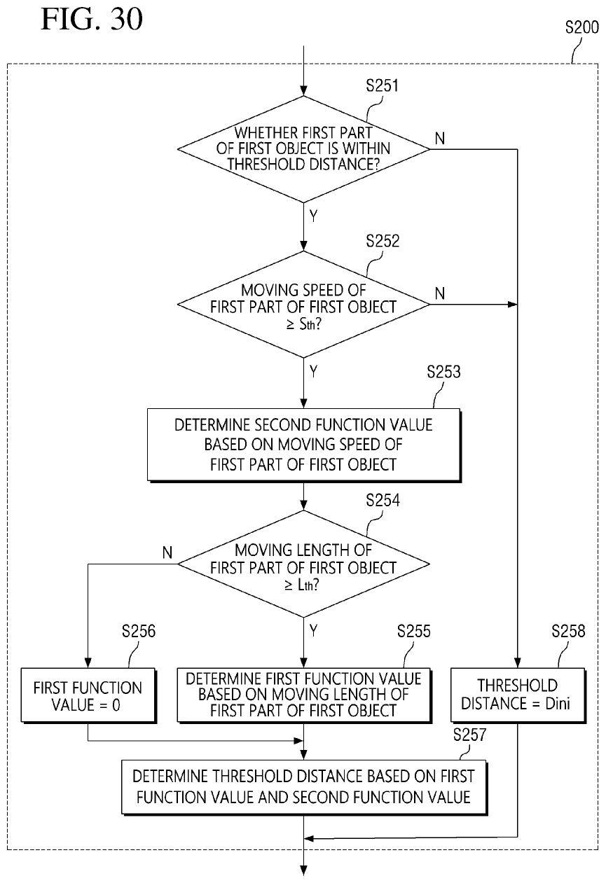

FIG. 30 is a flowchart showing another embodiment, in which step S200 of FIG. 25 is further embodied. In FIG. 30, the threshold distance is changed based on the moving length and the moving speed of the first part of the first object, but the threshold distance is changed under the condition that the first part of the first object is within the threshold distance from the second part.

In step S251, it is determined whether the first part of the first object is within a threshold distance (Dth) from the second part. If the first part is within the threshold distance (Dth) from the second part, the present embodiment proceeds to step S252, and it is determined whether the moving speed of the first part of the first object is equal to or greater than the threshold speed (Sth). On the other hand, if the first part is outside the threshold distance (Dth) from the second part, the present embodiment proceeds to step S258, and the threshold distance is initialized to an initial value (Dini).

In step S252, if the moving speed of the first object or the first part is greater than or equal to the threshold speed (Sth), the present embodiment proceeds to step S253, and a second function value is determined based on the moving speed of the first part of the first object. On the other hand, if the moving speed of the first part of the first object is less than the threshold speed (Sth), the present embodiment proceeds to step S258, and the threshold distance is initialized to the initial value (Dini).

After the second function value is determined in step S253, the present embodiment proceeds to step S254. In step S254, it is determined whether the moving length of the first part of the first object is greater than or equal to the threshold length (Lth). If the moving length of the first part of the first object is greater than or equal to the threshold length (Lth), the present embodiment proceeds to step S255, and a first function value is determined based on the moving length of the first part of the first object. On the other hand, if the movement length of the first part of the first object is less than the threshold length (Lth), the present embodiment proceeds to step S256, and the first function value becomes 0.

In step S257, the threshold distance is determined based on the first function value and the second function value. For example, the threshold distance may be determined as a value obtained by adding a first function value and a second function value to an initial threshold distance value.

Meanwhile, in the embodiment of FIG. 30, step S251 may be selectively deleted. For example, step S251 may be omitted and the present embodiment may be started from step S252.

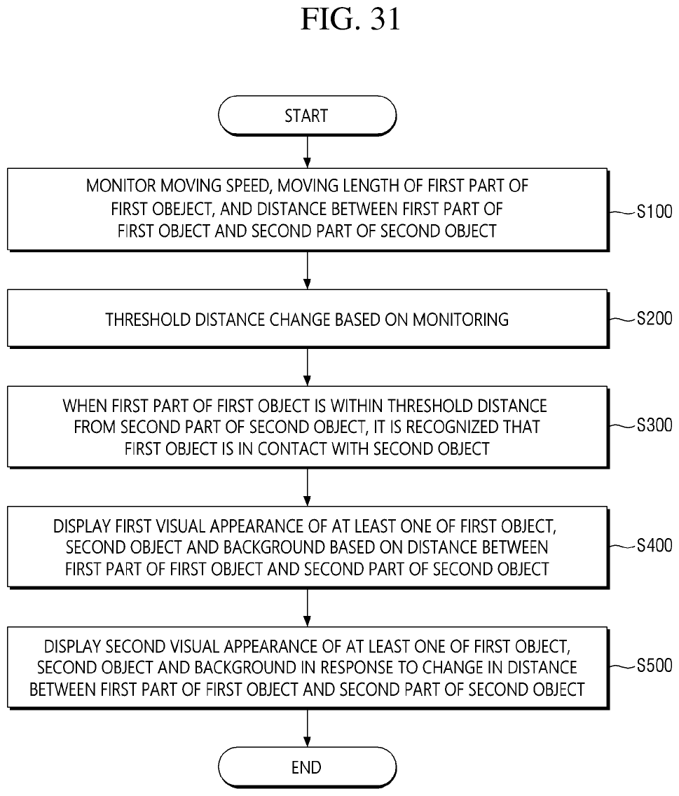

FIG. 31 is a flowchart illustrating some other embodiments of the present disclosure. In FIG. 31, an embodiment of changing the visual appearance of at least one of a first object, a second object, and a background in response to a change in the distance between the first part and the second part is described.

In the embodiment of FIG. 31, steps S100 to S300 are substantially the same as those described in FIGS. 25 to 30 above. Therefore, the description of steps S100 to S300 will be omitted for the sake of simplicity.

In step S400, a first visual appearance of at least one of the first object, the second object, and the background is displayed based on the distance between the first part of the first object and the second part of the second object.

In step S500, in response to a change in the distance between the first part of the first object and the second part of the second object, a second visual appearance of at least one of the first object, the second object, and the background is displayed. In this case, the second visual appearance may be a display, in which the first visual appearance is changed. Further, the first visual appearance and the second visual appearance may be different from each other.

The first visual appearance and the second visual appearance have the same technical characteristics as those described in FIGS. 20 to 24C.

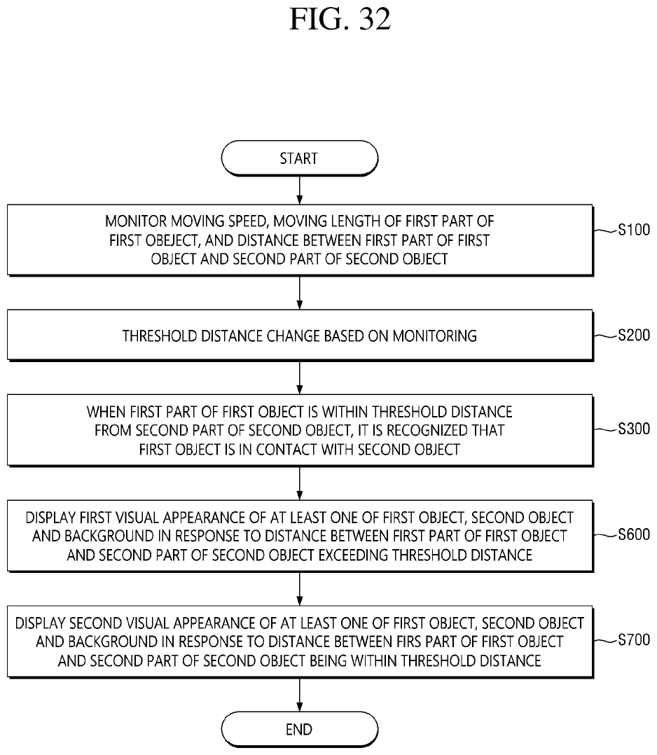

FIG. 32 is a flowchart illustrating still another exemplary embodiment of the present disclosure. In FIG. 32, similar to FIG. 31, an embodiment of changing the visual appearance of at least one of a first object, a second object, and a background in response to a change in the distance between the first part and the second part is described. However, in FIG. 32, different visual appearances are displayed depending on whether the first part of the first object is within a threshold distance from the second part.

In the embodiment of FIG. 32, steps S100 to S300 are substantially the same as those described in FIGS. 25 to 30 above. Therefore, the description of steps S100 to S300 will be omitted for the sake of simplicity.

In step S600, in response to the distance between the first part of the first object and the second part of the second object exceeding the threshold distance, a first visual appearance of at least one of the first object, the second object, and the background is displayed.

In step S700, in response to the distance between the first part of the first object and the second part of the second object being within the threshold distance, a second visual appearance of at least one of the first object, the second object, and the background is displayed. In this case, the second visual appearance may be a display, in which the first visual appearance is changed. In addition, the first visual appearance and the second visual appearance may be different from each other.

The first visual appearance and the second visual appearance have the same technical characteristics as those of the visual appearances described in FIGS. 20 to 24C.

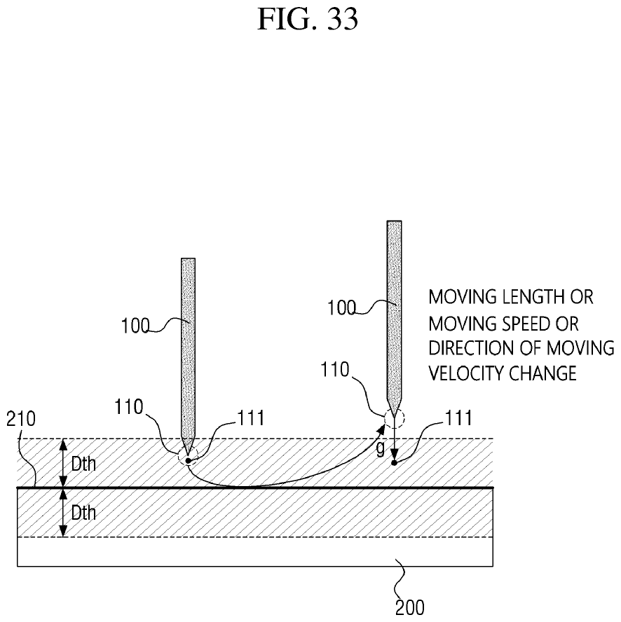

FIG. 33 is a diagram for describing an embodiment of recognizing a contact between virtual objects using a touch point of a virtual object according to the present disclosure. In this embodiment, the contact between the first object 100 and the second object 200 is defined in the following manner.

The touch point 111 of the first object 100 is set at an initial position that is a relative position with respect to the first part 110 of the first object 100. The touch point 111 may be included inside the first object 100 or may exist outside the first object 100 in a state separated from the first object 100. The touch point 111 may be a point that exists in space but has only a location without the volume, or may be an object that exists in a virtual reality space or an augmented reality space. For example, the touch point 111 may be expressed in the form of an ink drop on a virtual reality space or an augmented reality space.

If the touch point 111 is within a threshold distance from the second part 210 of the second object 200, it is recognized that the first object 100 and the second object 200 are in contact.

When the moving length or the moving speed of the first part 110 of the first object 100 changes, the relative position of the touch point 111 with respect to the first part 110 of the first object 100 changes, as a result, contact and contact recognition between the first portion 110 and the second portion 210 are stably performed. For example, when the moving length or moving speed of the first part 110 increases, the relative position of the touch point 111 with respect to the first part 110 changes so that the touch point 111 moves further away from the first part 110 toward the second part 210 (g). As a result, since the touch point 111 is still located within a threshold distance from the second part 210, the contact and the contact recognition between the first part 110 and the second part 210 can be stably performed.

On the other hand, in the embodiment described with reference to FIG. 33, even when the relative moving length, relative moving speed, or direction of moving velocity of the first part 110 of the first object 100 changes, the relative position of the touch point 111 with respect to the first part 110 of the first object 100 may be changed, and thus the contact and the contact recognition between the first part 110 and the second part 210 may be stably performed.

Meanwhile, in the embodiments of the present disclosure described with reference to FIGS. 1 to 33, a configuration, in which a threshold distance is changed based on a moving distance, a moving speed, a direction of a moving velocity, a relative moving distance, or a relative moving speed, a configuration, in which the shape of the first object 100 or the second object 200 is changed based on a moving distance, a moving speed, a direction of a moving velocity, a relative moving distance, or a relative moving speed, and a configuration, in which the relative position of the touch point 111 with respect to the first part 110 is changed based on a moving distance, a moving speed, a direction of a moving velocity, a relative moving distance, or a relative moving speed, may be combined with each other. For example, part of the increase or decrease of the total threshold distance required to maintain the contact stability between the first object 100 and the second object 200 can be replaced by extending or reducing a part of the first object 100 or the second object 200. Alternatively, part of the extension or reduction of a part of the first object 100 or the second object 200 required to maintain the contact stability between the first object 100 and the second object 200 can be replaced by increasing or decreasing the threshold distance. Alternatively, part of the change in the relative position of the touch point 111 with respect to the first part 110 required to maintain the contact stability between the first object 100 and the second object 200 can be replaced by increasing or decreasing the threshold distance.

Hereinafter, an exemplary computing device 500 capable of implementing the methods described in various embodiments of the present disclosure will be described with reference to FIG. 34.

FIG. 34 is an exemplary hardware configuration diagram illustrating the computing device 500. For example, the computing device 500 may be a system or a device, in which a method performed by a computer device that monitors a distance between virtual objects and recognizes a contact between virtual objects in a virtual reality environment or augmented reality environment according to the present disclosure is implemented.

As shown in FIG. 34, the computing device 500 may comprise one or more processors 510, a bus 550, a communication interface 570, a memory 530 that loads a computer program 591 performed by the processor 510, and a storage device 590 for storing the computer program 591. However, only components related to an embodiment of the present disclosure are shown in FIG. 34. Accordingly, those of ordinary skill in the art to which the present disclosure belongs may understand that other general-purpose components may be further included in addition to the components illustrated in FIG. 34. The computing device 500 illustrated in FIG. 34 may refer to any one of physical servers belonging to a server farm that provides an Infrastructure-as-a-Service (IaaS) type cloud service.

The processor 510 controls overall operations of each component of the computing device 500. The processor 510 may be configured to include at least one of a Central Processing Unit (CPU), a Micro Processor Unit (MPU), a Micro Controller Unit (MCU), a Graphics Processing Unit (GPU), or any type of processor well known in the art. Further, the processor 510 may perform calculations on at least one application or program for executing a method/operation according to various embodiments of the present disclosure. The computing device 500 may have one or more processors.

The memory 530 stores various data, instructions and/or information. The memory 530 may load one or more programs 591 from the storage 590 to execute methods/operations according to various embodiments of the present disclosure. An example of the memory 530 may be a RAM, but is not limited thereto.

The bus 550 provides communication between components of the computing device 500. The bus 550 may be implemented as various types of bus such as an address bus, a data bus and a control bus.

The communication interface 570 supports wired and wireless internet communication of the computing device 500. The communication interface 570 may support various communication methods other than internet communication. To this end, the communication interface 570 may be configured to comprise a communication module well known in the art of the present disclosure.

The storage 590 can non-temporarily store one or more computer programs 591. The storage 590 may be configured to comprise a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

Computer program 591 may include one or more instructions, in which method/actions according to various embodiments of the present disclosure are implemented. For example, the computer program 591 may comprise instructions for performing an operation of monitoring the moving speed of the first part of the first object, the moving length of the first part, and the distance between the first part and the second part of the second object, and an operation of recognizing that the first object is in contact with the second object when the distance between the first part and the second part is within a threshold distance, and the moving length of the first part is a moving length during the first part moves from the first point to the second point while maintaining a moving speed equal to or greater than a threshold speed, and the threshold distance may change based on the moving length or the moving speed of the first part.

When the computer program 591 is loaded into the memory 530, the processor 510 executes the one or more instructions to perform methods/operations according to various embodiments of the present disclosure.

Meanwhile, the computing device 500 may further include other additional components. For example, the computing device 500 may further include an input/output device. In this case, the input/output device may include a Virtual Reality Head Mounted Display (VR HMD), an Augmented Reality Head Mount Display (AR HMD), or at least one handheld controller.

Alternatively, the input/output device may include a display, an audio speaker, a microphone built-in or attached to a VR HMD or AR HMD, and the VR HMD, AR HMD, and at least one or more handheld controllers and VR HMD, AR HMD, or the handheld controllers may each include a Haptic Stimuli Actuator or a touch button or a capacitive type touch recognition unit.

In one embodiment, among the input/output devices, the output device implements VR or AR content through an HMD display or an audio speaker, and a method of monitoring distances of virtual objects and a method of recognizing contact between virtual objects according to embodiments of the present disclosure may be implemented in the content.

For example, to help the user recognize the distance and contact between virtual objects, the visual appearance may be displayed and changed on the VR HMD or AR HMD display by the method described in FIGS. 20 to 24C, or haptic stimulation may be implemented by to the haptic stimulation actuator or sound may be implemented through the audio speaker.

In one embodiment, among the input/output devices, the input device may generate virtual objects by activating or deactivating a touch button or a capacitive type touch recognition unit, or change the shape of the handheld controller to the shape of each of the virtual objects, or change the size or position of each of the virtual objects, or control the entire VR or AR system. Alternatively, by receiving a user's voice through the microphone of the VR HMD or AR HMD and by processing the user's voice by voice recognition, a control, similar to the above control performed through a touch button or a capacitive type touch recognition unit may be performed.

In one embodiment, the input device may include a VR or AR tracking device. The VR or AR tracking device may be at least one of optical cameras or at least one of magnetic tracking devices.

In one embodiment, the tracking device, which is in an independent unit from the VR HMD, AR HMD, or the handheld controller, may detect and track the VR HMD, the AR HMD, the handheld controller, the entire body of the VR or AR user, or a body part of the user, and the position data and the attitude data of the above objects to be rendered in VR space or AR space may be derived from the tracking device and rendered on the display of the VR HMD or AR HMD.

In one embodiment, the tracking device is not a separate form, but a form combined with the VR HMD or AR HMD, or a form combined with the handheld controller, or a form attached to the entire body of the VR or AR user, or a part of the user's body. The tracking device may track the external environment, and derive position data and the attitude data of objects, such as the VR HMD, the AR HMD, the handheld controller, the entire body of the VR or AR user, or a part of the user's body, from the tracked data, and render it on the display of the VR HMD or AR HMD.

In the case of a tracking device coupled to the VR HMD or AR HMD, the relative position and the relative attitude of the VR HMD or AR HMD may be derived based on data obtained by detecting and tracking an external environment. On the other hand, a hand or other objects may be directly detected and tracked by the tracking device of the VR HMD or AR HMD to obtain the attitude and the position data of the objects.

In one embodiment, when the tracking devices are one or more magnetic tracking devices, one or more magnetic field generators and the magnetic field detectors or the magnetic field generators may be distributedly coupled to each of the VR HMD, AR HMD or the handheld controllers, or may be independent.

In one embodiment, the tracking devices may extract the gesture command in real time from the continuous movement of each object or a part of the user's body based on the position and the attitude data of the VR HMD or AR HMD, the handheld controllers, and the entire body or part of the body of the VR or AR user and use it as input data.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although the operations are illustrated in a specific order in the drawings, it should not be understood that the operations should be executed in the specific order shown or in a sequential order, or all illustrated operations should be executed to obtain a desired result. In certain situations, multitasking and parallel processing may be advantageous. Moreover, the separation of the various elements in the above-described embodiments should not be understood as necessitating such separation, and it should be understood that the program components and systems described may be generally integrated together into a single software product or may be packaged into multiple software products.

Although embodiments of the present invention is described so far by referring to the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. A method performed by a computer device for monitoring a distance between virtual objects and recognizing a contact between virtual objects in a virtual reality environment or an augmented reality environment comprising:
monitoring a moving speed of a first part of a first object, a moving length of the first part, and a distance between the first part and a second part of a second object; and
recognizing that the first object is in contact with the second object when the distance between the first part and the second part is within a threshold distance,
wherein the moving length of the first part is a moving length during the first part moves from a first point to a second point while maintaining the moving speed equal to or greater than a threshold speed,
wherein the threshold distance varies based on the moving length of the first part.

2. The method of claim 1, wherein the first point is a position of the first part at a moment when the moving speed of the first part increases from less than the threshold speed to equal to or greater than the threshold speed,
wherein the second point is a position of the first part at a moment when the moving speed of the first part decreases from equal to or greater than the threshold speed to less than the threshold speed.

3. The method of claim 1, wherein the threshold distance is set to an initial value if the moving speed of the first part is less than the threshold speed.

4. The method of claim 1, wherein the moving speed of the first part is a magnitude of a linear velocity of the first part at a moment when the first part moves.

5. The method of claim 1, wherein the moving speed of the first part is a value obtained by dividing the moving length of the first part by a time taken for the first part to move from the first point to the second point.

6. The method of claim 1, wherein the moving length of the first part is a length of the entire path that the first part moved from the first point to the second point.

7. The method of claim 1, wherein the moving length of the first part is a straight distance between the first point and the second point.

8. The method of claim 1, wherein the first part moves in a first path while maintaining the moving speed equal to or greater than the threshold speed from a third point to a fourth point and,
wherein the first point is a point on the first path,
wherein the second point is a point having the longest straight distance from the first point among a plurality of points on the first path,
wherein the moving length of the first part is a straight distance between the first point and the second point.

9. The method of claim 1, wherein the first part moves in a first path while maintaining the moving speed equal to or greater than the threshold speed from a third point to a fourth point,
wherein the first point is a point on the first path,
wherein the second point is a point having the longest straight distance from the first point among a plurality of points on the first path,
wherein the moving length of the first part is a length of a second path, in which the first part moved from the first point to the second point.

10. The method of claim 1, wherein the threshold distance is determined by at least one of a first relational function having the moving length of the first part as a parameter and a second relational function having the moving speed of the first part as a parameter,
wherein the moving speed of the first part is a moving speed of the first part during the first part moves from the first point to the second point while maintaining the moving speed equal to or greater than the threshold speed,
wherein the threshold distance is set to an initial value if the moving speed of the first part is less than the threshold speed.

11. The method of claim 1, wherein the moving length of the first part is a relative moving length of the first part with respect to the second part.

12. The method of claim 1, wherein the moving speed of the first part is a relative moving speed of the first part with respect to the second part.

13. The method of claim 1, wherein the threshold distance varies based on the moving length of the first part while the distance between the first part and the second part is within the threshold distance,
wherein the threshold distance is set to an initial value when the distance between the first part and the second part exceeds the threshold distance.

14. The method of claim 1, wherein the threshold distance varies based on the moving speed of the first part while the distance between the first part and the second part is within the threshold distance,
wherein the threshold distance is set to an initial value when the distance between the first part and the second part exceeds the threshold distance.

15. The method of claim 1, wherein the threshold distance varies based on the moving length of the first part when the moving length of the first part exceeds a threshold length.

16. The method of claim 15, wherein the threshold distance is set to an initial value if the moving length of the first part is less than the threshold length.

17. The method of claim 1 further comprises,
displaying a first visual appearance of at least one of the first object, the second object, and a background based on the distance between the first part and the second part;
displaying a second visual appearance of at least one of the first object, the second object, and the background in response to a change in the distance between the first part and the second part,
wherein the first visual appearance and the second visual appearance are different from each other.

18. The method of claim 1 further comprises,
displaying a first visual appearance of at least one of the first object, the second object, and a background in response to the distance between the first part and the second part exceeding the threshold distance;
displaying a second visual appearance of at least one of the first object, the second object, and the background in response to the distance between the first part and the second part being within the threshold distance,
wherein the first visual appearance and the second visual appearance are different from each other.

19. A method performed by a computer device for monitoring a distance between virtual objects and recognizing a contact between virtual objects in a virtual reality environment or an augmented reality environment comprising:
monitoring a moving velocity of a first part of a first object and a distance between the first part and a second part of a second object; and
recognizing that the first object is in contact with the second object when the distance between the first part and the second part is within a threshold distance,
wherein the moving velocity of the first part comprises a first direction component and a second direction component,
wherein a direction of the moving velocity of the first part is determined based on a ratio of the first direction component to the second direction component,
wherein the threshold distance varies based on the direction of the moving velocity of the first part.

20. A method performed by a computer device for monitoring a distance between virtual objects and recognizing a contact between virtual objects in a virtual reality environment or an augmented reality environment comprising:
monitoring a distance between a first part of a first object and a second part of a second object, and a relative moving speed of the first part with respect to the second part; and
recognizing that the first object is in contact with the second object when the distance between the first part and the second part is within a threshold distance,
wherein the relative moving speed of the first part is a magnitude of a relative moving velocity of the first part with respect to the second part,
wherein the threshold distance varies based on the relative moving speed of the first part while the distance between the first part and the second part is within the threshold distance,
wherein the threshold distance is set to an initial value when the distance between the first part and the second part exceeds the threshold distance.
